(19) United States
(12) Patent Application Publication
(10) Pub. No.: US 2026/0364878 A1
(43) Pub. Date: Nov. 19, 2026

(54) 3D PRINTER

(71) Applicant: SHENZHEN TUOZHU TECHNOLOGY CO., LTD., Shenzhen (CN)

(72) Inventors: Li LIU, Shenzhen (CN); Zhihao DING, Shenzhen (CN); Zhao TONG, Shenzhen (CN); Xin LIU, Shenzhen (CN); Jiarong HUANG, Shenzhen (CN); Xuejian JIN, Shenzhen (CN)

(21) Appl. No.: 19/724,782

(22) Filed: Jun. 29, 2026

Related U.S. Application Data
(63) Continuation of application No. PCT/CN2025/112291, filed on Aug. 1, 2025.

(30) Foreign Application Priority Data
Jan. 15, 2025 (WO) PCT/CN2025/072614

(51) Int. Cl. B29C 64/218; B29C 64/118; B29C 64/209; B29C 64/241; B33Y 30/00

(52) U.S. Cl. CPC B29C 64/218; B29C 64/118; B29C 64/209; B29C 64/241; B33Y 30/00

(57) ABSTRACT

Disclosed is a 3D printer. The 3D printer includes a first extrusion assembly, a driving member, a guide member, and a 3D printing head. The first extrusion assembly is spaced apart from the 3D printing head. The driving member is configured to drive the 3D printing head to slide on the guide member. The 3D printing head includes a first hot end assembly, a second hot end assembly, and a second extrusion assembly. The first extrusion assembly is configured to drive a first filament to convey the first filament to the first hot end assembly. The second extrusion assembly is configured to drive a second filament to convey the second filament to the second hot end assembly. When the driving member drives the 3D printing head, the first extrusion assembly does not need to move along with the 3D printing head on the guide member.

### CROSS-REFERENCE TO RELATED APPLICATIONS

This application is a continuation of International Patent Application No. PCT/CN 2025/112291, filed on Aug. 1, 2025, which claims priority to International Patent Application No. PCT/CN 2025/072614, filed on Jan. 15, 2025. The disclosures of the aforementioned applications are hereby incorporated by reference in their entireties.

### FIELD

The present disclosure relates to the field of 3D printing, and in particular, to a 3D printer.

### BACKGROUND

A 3D printer uses a 3D printing head to print a three-dimensional product. Since the three-dimensional product may include different colors or different materials, the 3D printer needs to provide a variety of different filaments during printing.

At present, in order to improve the efficiency of switching between different filaments, some 3D printers integrate functions such as filament switching into the 3D printing head. However, this results in a larger and heavier 3D printing head, thereby greatly reducing the movement speed of the 3D printing head during the printing process.

### SUMMARY

The present disclosure discloses a 3D printer, which is conducive to reducing the volume of a 3D printing head and improving the movement speed of the 3D printing head during a printing process.

The present disclosure provides a 3D printer. The 3D printer includes a first extrusion assembly, a driving member, a guide member, and a 3D printing head, where the first extrusion assembly is spaced apart from the 3D printing head; the 3D printing head is slidably connected to the guide member, and the driving member is in transmission connection with the 3D printing head; the 3D printing head includes a connecting frame, a first hot end assembly, a second hot end assembly, and a second extrusion assembly. The first hot end assembly, the second hot end assembly, and the second extrusion assembly are connected to the connecting frame; the first extrusion assembly is configured to drive a first filament to convey the first filament to the first hot end assembly. The first extrusion assembly includes a first motor and two extrusion wheels. The first motor is in transmission connection with at least one of the two extrusion wheels, a gap between the two extrusion wheels in the first extrusion assembly is configured to allow the first filament to pass through, and the two extrusion wheels in the first extrusion assembly are configured to jointly clamp the first filament and convey the first filament to the first hot end assembly. The second extrusion assembly is configured to drive a second filament to convey the second filament to the second hot end assembly.

In this solution, when the driving member drives the 3D printing head, the first extrusion assembly does not need to move along with the 3D printing head on the guide member, thereby reducing the output burden on the driving member when driving the 3D printing head. Since the first extrusion assembly is not integrated in the 3D printing head, the volume of the 3D printing head can be reduced, and the weight of the 3D printing head can be decreased, thereby preventing the 3D printing head from being excessively heavy under the driving of the driving member, and improving the movement speed of the 3D printing head during product printing.

### BRIEF DESCRIPTION OF THE DRAWINGS

FIG. 1 is a schematic structural diagram of a 3D printer according to an embodiment of the present disclosure;

FIG. 2 is a schematic structural diagram of a 3D printing head according to an embodiment of the present disclosure;

FIG. 3 is a schematic structural diagram of a first extrusion assembly according to an embodiment of the present disclosure;

FIG. 4 is a top view of the first extrusion assembly in FIG. 3;

FIG. 5 is a schematic structural diagram of a second extrusion assembly according to an embodiment of the present disclosure;

FIG. 6 is a schematic diagram of a partial structure of a 3D printing head from one angle of view according to an embodiment of the present disclosure;

FIG. 7 is a schematic structural diagram of a 3D printing head colliding with an impact mechanism according to an embodiment of the present disclosure;

FIG. 8 is a partial schematic diagram of FIG. 7;

FIG. 9 is a schematic structural diagram of an impact mechanism according to an embodiment of the present disclosure;

FIG. 10 is a schematic structural diagram of another impact mechanism according to an embodiment of the present disclosure;

FIG. 11 is a schematic structural diagram illustrating a connection between a lifting mechanism and a first hot end assembly according to an embodiment of the present disclosure;

FIG. 12 is a schematic structural diagram of a first hot end assembly located at a first position according to an embodiment of the present disclosure;

FIG. 13 is a schematic structural diagram of a first hot end assembly located at a second position according to an embodiment of the present disclosure;

FIG. 14 is a schematic structural diagram of a connecting frame connecting a lifting mechanism according to an embodiment of the present disclosure;

FIG. 15 is a schematic diagram of a partial structure of a 3D printing head from another angle of view according to an embodiment of the present disclosure;

FIG. 16 is a schematic diagram of a partial structure of a 3D printing head from yet another angle of view according to an embodiment of the present disclosure;

FIG. 17 is a schematic diagram of a partial structure of a 3D printing head from yet another angle of view according to an embodiment of the present disclosure;

FIG. 18 is a schematic structural diagram of the 3D printing head in FIG. 2 from another angle of view;

FIG. 19 is a top view of an extrusion front casing according to an embodiment of the present disclosure;

FIG. 20 is a schematic diagram of a three-dimensional structure of an extrusion front casing according to an embodiment of the present disclosure;

FIG. 21 is a schematic diagram of a partial structure of a 3D printing head from yet another angle of view according to an embodiment of the present disclosure;

FIG. 22 is a schematic structural diagram illustrating a detachable connection between a first extrusion assembly and a housing according to an embodiment of the present disclosure;

FIG. 23 is a schematic structural diagram of a first extrusion assembly according to an embodiment of the present disclosure;

FIG. 24 is a cross-sectional diagram of the first extrusion assembly in FIG. 23;

FIG. 25 is another cross-sectional diagram of the first extrusion assembly in FIG. 23;

FIG. 26 is a schematic diagram of a partial structure of a housing according to an embodiment of the present disclosure;

FIG. 27 is a schematic structural diagram illustrating a fitting connection between a second filament tube connector and a housing according to an embodiment of the present disclosure;

FIG. 28 is a schematic structural diagram illustrating the fitting connection between the second filament tube connector and the housing in FIG. 27 from another angle of view;

FIG. 29 is a schematic structural diagram illustrating a fitting connection between a second filament tube connector and a housing from yet another angle of view according to an embodiment of the present disclosure;

FIG. 30 is a schematic structural diagram illustrating a fitting connection between a second filament tube connector and a housing from yet another angle of view according to an embodiment of the present disclosure;

FIG. 31 is a schematic structural diagram of a second filament tube connector according to an embodiment of the present disclosure; and

FIG. 32 is a schematic diagram of yet another partial structure of a housing according to an embodiment of the present disclosure.

### DETAILED DESCRIPTION

To make the embodiments of the present disclosure clearer, a further detailed description of the present disclosure is provided in conjunction with the accompanying drawings.

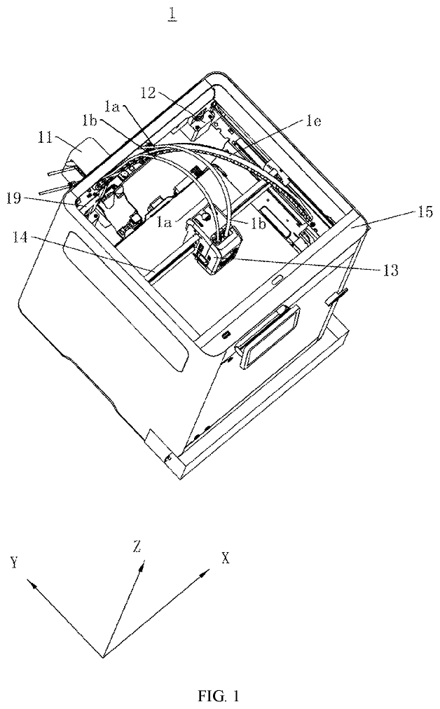

Referring to FIG. 1, the present disclosure provides a 3D printer 1. The 3D printer 1 may include a first extrusion assembly 11, a driving member 12, a guide member 14, and a 3D printing head 13. The first extrusion assembly 11 is spaced apart from the 3D printing head 13. The 3D printing head 13 is slidably disposed on the guide member 14, and the driving member 12 is in transmission connection with the 3D printing head 13.

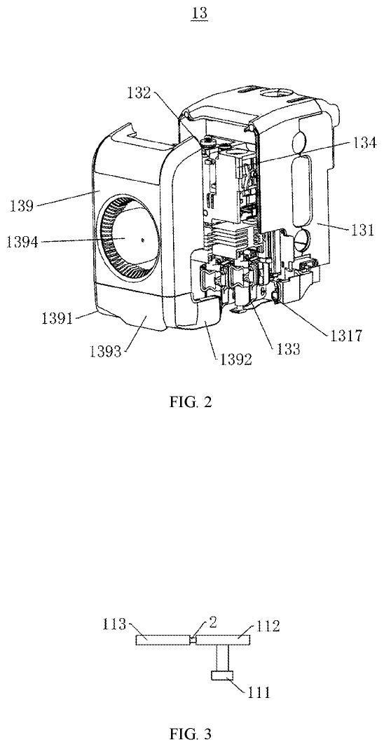

Referring to FIG. 2, the 3D printing head 13 includes a connecting frame 131, a first hot end assembly 132, a second hot end assembly 133, and a second extrusion assembly 134. The first hot end assembly 132, the second hot end assembly 133, and the second extrusion assembly 134 are connected to the connecting frame 131. The first extrusion assembly 11 is configured to drive a first filament 2 to convey the first filament 2 to the first hot end assembly 132, and the second extrusion assembly 134 is configured to drive a second filament 3 to convey the second filament 3 to the second hot end assembly 133. At least one of the first hot end assembly 132 and the second hot end assembly 133 is movably connected to the connecting frame 131. Illustratively, the first hot end assembly 132 is movably connected to the connecting frame 131, and the second hot end assembly 133 is fixedly connected to the connecting frame 131. Further illustratively, the first hot end assembly 132 is movably connected to the connecting frame 131, and the second hot end assembly 133 is also movably connected to the connecting frame 131.

In some feasible embodiments, the guide member 14 may be a carbon rod, a linear rail, or the like, and the connecting frame 131 is provided with a through hole for the carbon rod or the linear rail to pass through, thereby achieving a sliding connection between the 3D printing head 13 and the guide member 14.

In the embodiments according to the present disclosure, the 3D printer 1 may further include a processing platform, and the 3D printing head 13 prints a product on the processing platform during printing. During the process of printing the product with the 3D printing head 13, the first hot end assembly 132 can heat the first filament 2 to a molten state, and then eject the filament in a molten state onto the processing platform to process the product. The second hot end assembly 133 can heat the second filament 3 to a molten state, and then eject the second filament 3 in a molten state onto the processing platform to process the product. The processing platform can move up and down. As the printed product gradually builds up in thickness during the printing process of the 3D printing head 13, the processing platform may gradually descend, and the 3D printing head 13 is always located above the product. The above description is specific to the 3D printer with a core xy structure. In some feasible embodiments, in a cantilever-type 3D printer or a gantry-type 3D printer, the first hot end assembly and the second hot end assembly may heat the filament to a molten state and eject the filament onto the processing platform. During the process in which the hot end assembly ejects the filament in a molten state onto the processing platform, the processing platform may move along the y-axis, while the 3D printing head moves up and down along the Z-axis and moves along the X-axis to achieve the processing of a three-dimensional object. In the drawings of the present disclosure, a 3D printer with a core xy structure is taken as an example, which does not constitute a limitation on the structure of the 3D printer of the present disclosure. The solutions of the present disclosure may also be applied to 3D printers with other structures, such as cantilever-type and gantry-type structures.

The 3D printing head 13 may switch between using the first hot end assembly 132 and the second hot end assembly 133, thereby switching the filament ejected onto the processing platform to form the product. For example, the product may be formed by processing the first filament 2 and the second filament 3. By using the 3D printing head 13 to switch between the first hot end assembly 132 and the second hot end assembly 133, the first filament 2 and the second filament 3 can be alternately melted (where the first hot end assembly 132 can heat the first filament 2 to enable the first filament 2 to be in a molten state, and the second hot end assembly 133 can heat the second filament 3 to enable the second filament 3 to be in a molten state). The first hot end assembly 132 ejects the first filament 2 in a molten state onto the processing platform, and the second hot end assembly 133 ejects the second filament 3 in a molten state onto the processing platform. The first filament 2 and the second filament 3 in a molten state form the product on the processing platform, thereby improving the processing efficiency and reducing waste materials. The reason lies in that the addition of the hot end assemblies allows different hot end assemblies to be used to heat different filaments. For example, the capacity of heating filaments of different colors eliminates the need for additional flushing time to clean the residues of the previous filament in the hot end assembly, and avoids the waste of flushing filament.

Illustratively, when the 3D printing head 13 prints a product, the 3D printing head 13 ejects a material through the first hot end assembly 132 or the second hot end assembly 133, the driving member 12 drives the 3D printing head 13 to move according to a preset trajectory. The driving member 12 may drive the 3D printing head 13 to move along a first direction (e.g., an X-axis direction), and the driving member 12 may also drive the 3D printing head 13 to move along a second direction (e.g., a Y-axis direction). When the first hot end assembly 132 ejects the first filament 2 in a molten state, the 3D printing head 13 moves according to a part of the preset trajectory; when the second hot end assembly 133 ejects the second filament 3 in a molten state, the 3D printing head 13 moves according to another part of the preset trajectory.

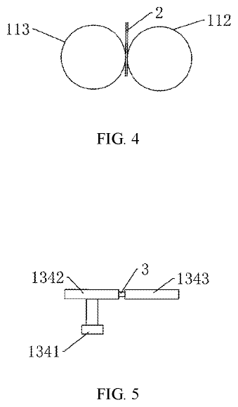

In the embodiments according to the present disclosure, when the first hot end assembly 132 ejects the first filament 2 in a molten state, the first filament 2 may be conveyed to the first hot end assembly 132 via the first extrusion assembly 11. In one embodiment, referring to FIGS. 3 and 4, the first extrusion assembly 11 includes a first motor 111, an extrusion wheel 112, and an extrusion wheel 113. The first motor 111 may be in transmission connection with the extrusion wheel 112. In some feasible embodiments, the first motor 111 may be in transmission connection with the extrusion wheel 113. In one embodiment, the first motor 111 may be in transmission connection with the extrusion wheel 112 and the extrusion wheel 113.

Illustratively, the outer peripheral surface of the extrusion wheel 112 may be spaced apart from the outer peripheral surface of the extrusion wheel 113. A gap is formed between the extrusion wheel 112 and the extrusion wheel 113 for the first filament 2 to pass through, and the first filament 2 is simultaneously in contact with the outer peripheral surface of the extrusion wheel 112 and the outer peripheral surface of the extrusion wheel 113. The outer peripheral surfaces of the two extrusion wheels jointly clamp the first filament 2. The first motor 111 drives the extrusion wheel 112 to rotate, and the conveying of the first filament 2 is achieved through the clamping friction between the extrusion wheel 112 and the extrusion wheel 113 on the first filament 2. For example, the first filament 2 is conveyed from the first extrusion assembly 11 to the first hot end assembly 132. In one embodiment, the first motor 111 simultaneously drives the extrusion wheel 112 and the extrusion wheel 113. Through the clamping and conveying of the first filament 2 by the extrusion wheel 112 and the extrusion wheel 113, the first filament 2 is conveyed to the first hot end assembly 132.

When the second hot end assembly 133 ejects the second filament 3 in a molten state, the second filament 3 may be conveyed to the second hot end assembly 133 through the second extrusion assembly 134. Referring to FIG. 5, the second extrusion assembly 134 includes a second motor 1341, an extrusion wheel 1342, and an extrusion wheel 1343. The second motor 1341 may drive the extrusion wheel 1342 to rotate. The outer peripheral surface of the extrusion wheel 1342 is spaced apart from the outer peripheral surface of the extrusion wheel 1343. A gap between the outer peripheral surfaces of the extrusion wheel 1342 and the extrusion wheel 1343 allows the second filament 3 to pass through. In addition, the second filament 3 is simultaneously in contact with the outer peripheral surface of the extrusion wheel 1342 and the outer peripheral surface of the extrusion wheel 1343, and the outer peripheral surfaces of the two extrusion wheels jointly clamp the second filament 3. The second motor 1341 drives the extrusion wheel 1342 to rotate, and the conveying of the second filament 3 is achieved through the clamping friction between the extrusion wheel 1342 and the extrusion wheel 1343 on the second filament 3. For example, the second filament 3 is conveyed from the second extrusion assembly 134 to the second hot end assembly 133. In one embodiment, the second motor 1341 may simultaneously drive the extrusion wheel 1342 and the extrusion wheel 1343 to rotate. Through the clamping and conveying of the second filament 3 by the extrusion wheel 1342 and the extrusion wheel 1343, the second filament 3 is conveyed to the second hot end assembly 133.

In the embodiments according to the present disclosure, the 3D printer 1 is provided with two extrusion assemblies. The second extrusion assembly 134 is disposed on the 3D printing head 13; that is, the second extrusion assembly 134 is disposed close to the second hot end assembly 133. The first extrusion assembly 11 is not disposed on the 3D printing head 13; that is, the first extrusion assembly 11 is disposed at a position relatively far from the first hot end assembly 132. It can be seen that the 3D printer according to the present disclosure may include a dual hot-end printer with a direct drive extrusion and a remote extrusion. Thus, when the driving member 12 drives the 3D printing head 13, the first extrusion assembly 11 does not need to move along with the 3D printing head 13 on the guide member 14, thereby reducing the output burden on the driving member 12 when driving the 3D printing head 13. Since the first extrusion assembly 11 is not integrated in the 3D printing head 13, the volume of the 3D printing head 13 can be reduced, and the weight of the 3D printing head 13 can be decreased, thereby preventing the 3D printing head 13 from being excessively heavy under the driving of the driving member 12, and improving the movement speed of the 3D printing head 13 during product printing. Therefore, the present disclosure can not only achieve the advantages of the dual hot-end printer, such as improved processing efficiency and reduced waste materials, but also avoid the problems in existing dual hot-end printers where both extrusion assemblies are disposed on the 3D printing head, such as excessive weight and excessive volume of the 3D printing head, which may result in reduced movement speed and decreased control accuracy of the 3D printing head 13, and the like.

In the embodiments according to the present disclosure, the first filament 2 is a hard material filament, and the second filament 3 is a soft material filament. Illustratively, the hard material may be a material with relatively high rigidity or low elasticity, for example, PLA or PETG. The soft material may be a material with relatively low rigidity or high elasticity, for example, TPU or TPE. Since soft material filaments such as TPU have high elasticity and are soft and easily bendable, which imposes higher requirements on printing control, in the embodiments of the present disclosure, a remote extrusion assembly is used to convey the hard material filament, and a direct drive extrusion assembly is used to convey the soft material filament, to ensure the printing accuracy and the print quality of the soft material.

In the embodiments according to the present disclosure, the 3D printer 1 further includes a first filament tube 1a and a second filament tube 1b. A diameter of the first filament tube 1a is less than a diameter of the second filament tube 1b. The first filament tube 1a is configured to connect the first hot end assembly 132, and the second filament tube 1b is configured to connect the second hot end assembly 133. The first filament 2 passes through the first filament tube 1a and is conveyed to the first hot end assembly 132, and the second filament 3 passes through the second filament tube 1b and is conveyed to the second hot end assembly 133. The first extrusion assembly 11 is relatively far away from the first hot end assembly 132, and the first filament tube 1a with a smaller diameter is used to convey the first filament 2, and a gap between the filament and the tube wall of the filament tube is relatively small. This reduces the circumferential movement space of the filament in the filament tube, thereby enabling accurate control over the filament position and facilitating stable straight-line advancement of the filament along the filament tube. In particular, in the remote extrusion configuration where the extrusion assembly is relatively far away from the hot end according to the present disclosure, the friction between the filament and the filament tube can be reduced, thereby avoiding the risk of material jamming.

In the embodiments according to the present disclosure, the second filament tube 1b is configured to allow the soft material filament to pass through, and the inner wall of the second filament tube 1b is provided with an axial pattern. The second filament tube 1b is connected to the second hot end assembly 133, and the second extrusion assembly 134 is used to print the soft material filament. The extrusion assembly is relatively close to the hot end, which can ensure a short and straight path between the extrusion assembly for conveying the soft material filament and the hot end assembly for heating and melting the soft material filament, thereby ensuring the control accuracy of the soft material and reducing the retraction of the soft material filament. Moreover, the resistance caused by the bending of the soft material filament can be reduced, thereby improving the success rate of conveying the soft material filament. Furthermore, the inner wall of the second filament tube 1b for conveying the soft material filament is provided with an axial pattern, which can reduce the contact area between the soft material filament and the filament tube, increase the air entering between the filament tube and the filament, and reduce the frictional force between the filament tube and the filament, thereby facilitating the conveying of the soft material filament.

In the embodiments according to the present disclosure, the 3D printer 1 is further connected to a feeding device, and the feeding device can accommodate the first filament 2 and the second filament 3. The feeding device can release the first filament 2 and the second filament 3. The first filament 2 extends from the feeding device, passes through the first extrusion assembly 11, and is conveyed to the first hot end assembly 132. The first hot end assembly 132 heats the first filament 2 and ejects the first filament 2 in a molten state. The first extrusion assembly 11 can drive the first filament 2 to convey the first filament 2 to the first hot end assembly 132. The second filament 3 extends from the feeding device, passes through the second extrusion assembly 134, and is conveyed to the second hot end assembly 133. The second hot end assembly 133 heats the second filament 3 and ejects the second filament 3 in a molten state. The second extrusion assembly 134 can drive the second filament 3 to convey the second filament 3 to the second hot end assembly 133.

In the 3D printing head with dual hot end assemblies, the position of the hot end assembly in the operating state is lower than the position of the hot end assembly in the idle state. Illustratively, when the 3D printing head 13 uses the first hot end assembly 132 to eject the first filament 2 in a molten state, the lowest position of the second hot end assembly 133 is higher than the lowest position of the first hot end assembly 132. During the process in which the driving member 12 drives the 3D printing head 13 to move, the interference (e.g., collision) between the second hot end assembly 133 and the product can be prevented. To improve the processing accuracy when the first hot end assembly 132 processes a product, the lowest position of the first hot end assembly 132 is slightly higher than the lowest position of the product. If the lowest position of the second hot end assembly 133 is lower than the lowest position of the first hot end assembly 132, the lowest position of the second hot end assembly 133 may be lower than the product, causing interference between the 3D printing head 13 and the product during movement.

When the 3D printing head 13 uses the second hot end assembly 133 to eject the second filament 3 in a molten state, the lowest position of the first hot end assembly 132 needs to be higher than the lowest position of the second hot end assembly 133. This can prevent the lowest position of the first hot end assembly 132 from being lower than the product, thereby preventing interference (e.g., collision) between the first hot end assembly 132 and the product during the movement of the 3D printing head 13.

In the embodiments according to the present disclosure, the first hot end assembly 132 is movably connected to the connecting frame 131, and the second hot end assembly 133 is fixedly connected to the connecting frame 131. By changing the relative position between the first hot end assembly 132 and the connecting frame 131, for example, by allowing the first hot end assembly 132 to move up and down relative to the processing platform on the connecting frame 131, the relative height position between the first hot end assembly 132 and the second hot end assembly 133 can be changed. For example, when the 3D printing head 13 uses the first hot end assembly 132 to eject the first filament 2, the relative position between the first hot end assembly 132 and the connecting frame 131 can be adjusted, and the lowest position of the first hot end assembly 132 is lower than the lowest position of the second hot end assembly 133. When the 3D printing head 13 uses the second hot end assembly 133 to eject the second filament 3, the relative position between the first hot end assembly 132 and the connecting frame 131 can be adjusted, and the lowest position of the first hot end assembly 132 is higher than the lowest position of the second hot end assembly 133. The height positions of the first hot end assembly 132 and the second hot end assembly 133 are defined along a Z-axis direction. During the implementation of the present disclosure, the vertically movable first hot end assembly 132 is used in conjunction with a remote extrusion assembly, such as the first extrusion assembly, to ensure the printing effect of the fixed second hot end assembly 133 and the second hot end assembly 133 with direct drive extrusion. This configuration is particularly suitable for use when the first hot end assembly 132 is configured to eject a support material and the second hot end assembly 133 is configured to eject the main body portion of a three-dimensional product. The reason lies in that the first extrusion assembly 11 is relatively far away from the first hot end assembly 132, making the conveyance amount of the first filament 2 difficult to control, thus making it difficult to ensure the printing quality. However, this configuration can be used to print a support portion that needs to be detached from the main body of the product, without affecting the appearance of the three-dimensional product due to print quality issues.

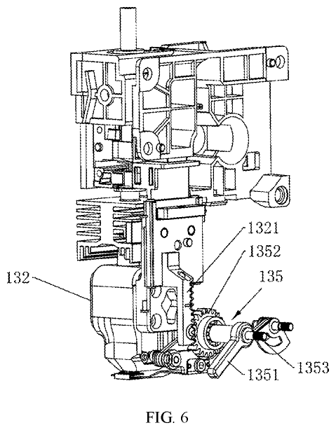

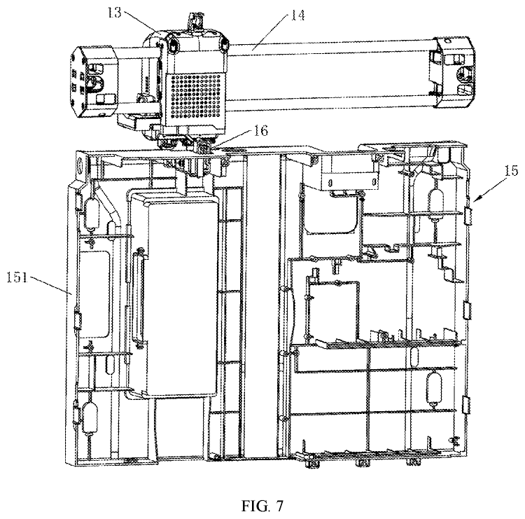

In some embodiments, the 3D printing head 13 further includes a lifting mechanism 135 connected to the connecting frame 131, and the lifting mechanism may be connected to at least one of the first hot end assembly 132 and the second hot end assembly 133. Illustratively, referring to FIGS. 6 and 7, the 3D printing head 13 further includes a lifting mechanism 135 connected to the connecting frame 131. FIG. 6 illustrates the example in which the lifting mechanism 135 is connected to the first hot end assembly 132. In one embodiment, in some other embodiments, the lifting mechanism 135 may be connected to the second hot end assembly 133. The 3D printer 1 may further include a housing 15 and an impact mechanism 16. The lifting mechanism 135 includes a trigger member 1351. The trigger member 1351 is configured to collide with the impact mechanism 16, to drive the hot end assembly movably connected to the connecting frame 131 to move up and down. The impact mechanism 16 is mounted on the housing 15.

In the embodiments according to the present disclosure, the housing 15 may include a base 151, and the processing platform is connected to the base 151. For example, the processing platform may be in transmission connection with the base 151 through a lead screw or a sliding block. The 3D printing head 13 is movable relative to the housing 15 along at least one of the first direction (e.g., the X-axis direction) and the second direction (e.g., the Y-axis direction), and the first direction and the second direction are perpendicular to each other.

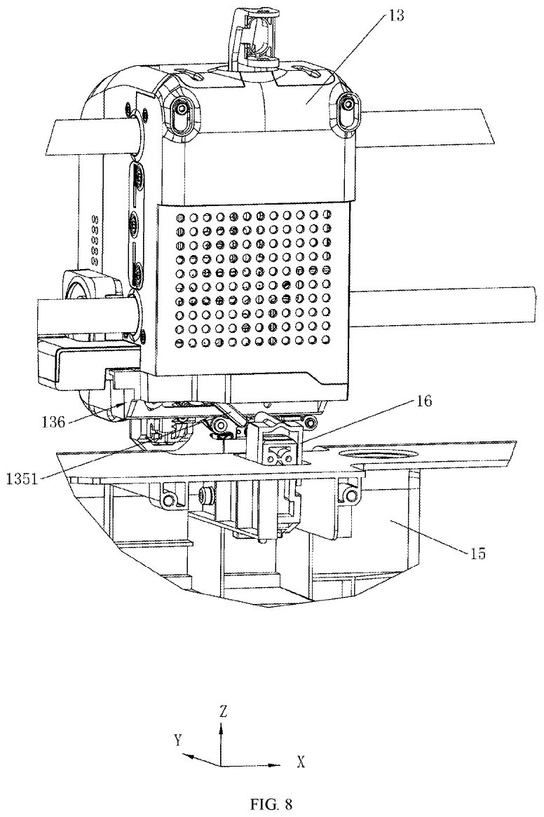

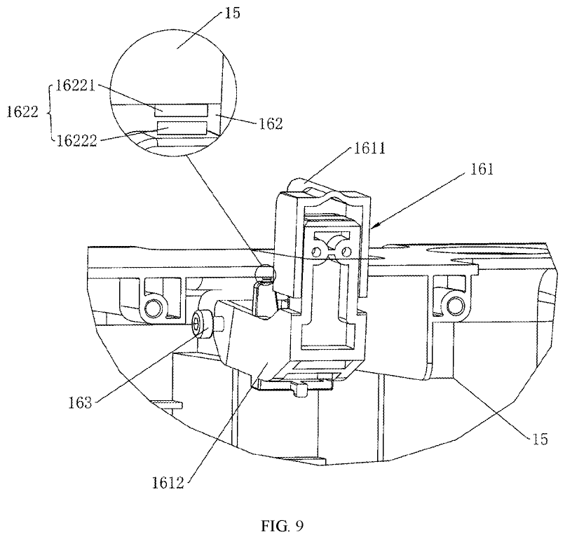

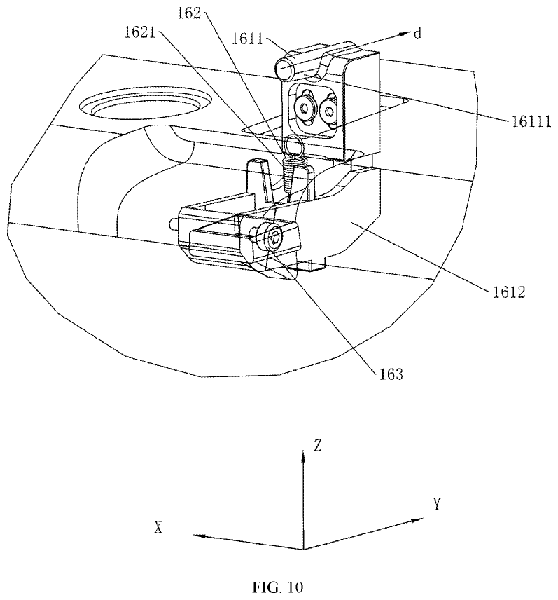

Referring to FIGS. 8, 9, and 10, the impact mechanism 16 includes a contact member 161 and a reset member 162. One end of the contact member 161 is hinged to the housing 15, and the axis about which the contact member 161 is hinged to the housing 15 is parallel to the first direction. Illustratively, taking the first direction being the X-axis direction as an example, the other end of the contact member 161 is configured to collide with the trigger member 1351 in the 3D printing head 13 that moves along the first direction, to drive the first hot end assembly 132 to move up and down. The contact member 161 and the reset member 162 are connected to the housing 15, and the reset member 162 includes an elastic member 1621 or a magnetic attraction component. One end of the contact member 161 hinged to the housing 15 is located below the upper surface of the base 151, and the other end of the contact member 161 is located above the inner surface of the housing 15.

In one embodiment, the impact mechanism 16 is connected to the base 151, one end of the contact member 161 is hinged to the base 151, and the other end of the contact member 161 protrudes from the upper surface of the base 151, to collide with the trigger member 1351 in the 3D printing head 13 that moves along the first direction. The end of the contact member 161 hinged to the base 151 is located below the upper surface of the base 151, and the other end of the contact member 161 is located above the upper surface of the base 151.

The contact member 161 is connected to the base 151 through the reset member 162. When the contact member 161 rotates relative to the base 151, the reset member 162 enables the contact member 161 to return to an initial state.

In a feasible implementation, the reset member 162 is connected between the contact member 161 and the base 151. The reset member 162 is an elastic member 1621, and when the contact member 161 is subjected to an external force (e.g., an impact from the 3D printing head 13 in the second direction), the elastic member 1621 can be elastically deformed. When the external force acting on the contact member 161 disappears, the elastic member 1621 resets, thereby causing the contact member 161 to return to the initial state. During the processing of the 3D printer, the 3D printing head 13 may experience a step loss fault and collide with the contact member 161 in the second direction, such as the Y-axis direction. To prevent the 3D printing head from being damaged due to collision with the impact mechanism 16, the contact member 161 is provided with a highly compliant reset member 162 in the direction where a large impact force does not need to be applied to the trigger member 1351, i.e., the second direction, rather than a high-rigidity contact structure, and the impact force between the 3D printing head and the contact member in the second direction can be absorbed in the event of the step loss fault of the 3D printing head.

In a feasible implementation, the reset member 162 is a magnetic attraction component 1622. The magnetic attraction component 1622 includes a first magnetic portion 16221 and a second magnetic portion 16222. The first magnetic portion 16221 is disposed on the housing 15, and the second magnetic portion 16222 is disposed on the contact member 161. When the reset member 162 is in the initial state, the first magnetic portion 16221 and the second magnetic portion 16222 are attracted together. When the contact member 161 is subjected to an external force (for example, an impact from the 3D printing head 13 in the second direction), the external force applied to the contact member 161 overcomes the magnetic attraction force between the first magnetic portion 16221 and the second magnetic portion 16222, causing the first magnetic portion 16221 and the second magnetic portion 16222 to separate. After the external force on the contact member 161 disappears, the first magnetic portion 16221 and the second magnetic portion 16222 are attracted together again by magnetic force. In one embodiment, the magnetic attraction component 1622 may include a magnetic member and a metal member. The magnetic member is disposed on the housing 15, and the metal member is disposed on the contact member 161.

In the embodiments according to the present disclosure, the housing 15 and the contact member 161 are connected via the reset member 162. When the contact member 161 is subjected to an external force, the reset member 162 can play a buffering role, which can reduce the impact force received by the 3D printing head 13 when the 3D printing head collides with the contact member 161, thereby protecting the 3D printing head 13.

When the 3D printing head 13 switches the hot end assembly through the lifting mechanism 135, for example, switching from ejecting the printing material from the first hot end assembly 132 to ejecting the printing material from the second hot end assembly 133, or switching from ejecting the printing material from the second hot end assembly 133 to ejecting the printing material from the first hot end assembly 132, the 3D printing head 13 can be manually moved to a set position, and then the 3D printing head 13 collides with the contact member 161 in the first direction. Then, the contact member 161 collides with the trigger member 1351, and the contact member 161 actuates the trigger member 1351. The movement of the trigger member 1351 can drive the first hot end assembly 132 or the second hot end assembly 133 to move up and down, or the trigger member 1351 drives one of the first hot end assembly 132 and the second hot end assembly 133 to move up while the other moves down. The lower one of the first hot end assembly 132 and the second hot end assembly 133 is caused to eject the printing material.

In the embodiments according to the present disclosure, the trigger member 1351 collides with the impact mechanism 16, enabling the lifting mechanism 135 to achieve passive lifting, thereby driving one of the first hot end assembly 132 or the second hot end assembly 133 to move up and down. Compared with active lifting, which requires a motor in the 3D printing head for switching the lifting of the hot end assembly, and in some cases further requires a motor for clamping the filament to cooperate with the lifting switching of the hot end assembly, the present disclosure adopts passive lifting of the hot end assembly, and no motor other than the extrusion assembly needs to be provided in the 3D printing head, thereby making the 3D printing head lightweight, compact in size, and easier to control.

In some embodiments, the reset member 162 is connected between the contact member 161 and the housing 15 in the second direction or a third direction, and the first direction, the second direction, and the third direction are perpendicular to each other. The term “perpendicular” mentioned in the embodiments of the present disclosure may not be absolutely perpendicular. For example, the first direction and the second direction are perpendicular to each other, an angular deviation of 10% is allowed between the first direction and the second direction, and the angle between the first direction and the second direction may be between 81° and 99°. An angular deviation of 10% is allowed between the first direction and the third direction, and the angle between the first direction and the third direction may be between 81° and 99°. An angular deviation of 10% is allowed between the second direction and the third direction, and the angle between the second direction and the third direction may be between 81° and 99°.

In the embodiments according to the present disclosure, the reset member 162 connects the contact member 161 and the housing 15 in the third direction, and the connection position between the reset member 162 and the contact member 161 is located between two ends of the contact member 161.

The impact mechanism 16 further includes a connecting shaft 163. The connecting shaft 163 penetrates through the contact member 161, the connecting shaft 163 is fixedly connected to the housing 15, and the contact member 161 is rotatably connected to the housing 15 via the connecting shaft 163.

The axial direction of the connecting shaft 163 is parallel to the first direction, and the connecting shaft 163 connects the contact member 161 and the housing 15, and the contact member 161 and the housing 15 can rotate relative to each other. In addition, the connecting shaft 163 can restrict the positions of the contact member 161 and the housing 15 in the first direction. When the trigger member 1351 in the 3D printing head 13 moves in the first direction and collides with the contact member 161, no relative displacement occurs between the contact member 161 and the housing 15, thereby ensuring relatively high rigidity of the contact member 161 in the first direction. When the contact member 161 collides with the trigger member 1351, the generated force mainly acts on the trigger member 1351 to drive the lifting mechanism 135 to move up and down, thereby facilitating the state switching of the lifting mechanism 135.

In the embodiments according to the present disclosure, the contact member 161 includes a rod portion 1611, an extending direction of the rod portion 1611 is parallel to the second direction, and the rod portion 1611 is configured to collide with the trigger member 1351. The extending direction of the rod portion 1611 is parallel to the second direction, which facilitates collision with the trigger member 1351 that moves in the first direction.

The contact member 161 includes a rod portion 1611, the extending direction of the rod portion 1611 is parallel to the second direction, the surface of the rod portion 1611 is provided with a contact region 16111, and the position of the contact region 16111 is lower than the position of the central axis d of the rod portion 1611. Since the position of the contact region 16111 is lower than the position of the central axis of the rod portion 1611, when the trigger member 1351 collides with the rod portion 1611, the rod portion 1611 applies a force with a downward component to the trigger member 1351. This ensures a stable contact between the trigger member 1351 and the rod portion 1611, and drives the trigger member 1351 to rotate, and the first hot end assembly 132 is switched from the second position to the first position.

The contact member 161 further includes a connecting seat 1612. One end of the connecting seat 1612 is located below the inner surface of the housing 15 and is rotatably connected to the housing 15, and the other end of the connecting seat 1612 protrudes from the inner surface of the housing 15 and is connected to the rod portion 1611. Since the rod portion 1611 collides with the trigger member 1351, the surface of the rod portion 1611 requires relatively high strength, smoothness, and the like. The rod portion 1611 is connected to the housing 15 through the connecting seat 1612, which can reduce the processing area of the surface of the rod portion 1611.

In the second direction, one end of the rod portion 1611 away from the connecting seat 1612 is closer to the hinge point between the connecting seat 1612 and the base 151 than one end of the rod portion 1611 close to the connecting seat 1612, and one side of the rod portion 1611 facing the hinge point is also the side facing the 3D printing head. The 3D printing head 13 can move above the connecting seat 1612, and the dimension of the connecting seat 1612 may not occupy the dimension of the 3D printer 1 in a depth direction. When the 3D printing head 13 moves along the second direction and collides with one end of the rod portion 1611 away from the connecting seat 1612, the contact member 161 rotates relative to the housing 15, and one end of the contact member 161 protruding from the upper surface of the base 151 sinks downward, thus not occupying the printing space constructed by the 3D printer 1. The printing space constructed by the 3D printer 1 refers to the space required by the 3D printing head 13 when printing a product.

In the embodiments according to the present disclosure, in order to reduce the probability of collision between the rod portion 1611 and other components of the 3D printing head 13 excluding the trigger member, the 3D printing head 13 is provided with an avoidance groove 136 in the extending direction of the rod portion 1611. The trigger member 1351 is located in the avoidance groove 136 and protrudes from the other components of the 3D printing head 13 excluding the trigger member. During the process in which the 3D printing head 13 moves along the first direction toward the position of the impact mechanism 16, the trigger member in the 3D printing head 13 collides with the rod portion 1611, and the components of the 3D printing head 13 excluding the trigger member do not collide with or contact the rod portion 1611. In the embodiments according to the present disclosure, the avoidance groove 136 can avoid the impact mechanism, thereby reducing the probability of collision between the 3D printing head 13 and the impact mechanism 16 in directions other than the first direction. For example, in the process that the 3D printing head 13 moves toward the position of the impact mechanism 16 along the second direction, the 3D printing head 13 can avoid the rod portion 1611 of the impact mechanism 16 through the avoidance groove 136, and the trigger member 1351 may be of a rod-shaped structure. For example, the trigger member 1351 may be a lever. In this way, the trigger member 1351 occupies a relatively small space in the avoidance groove 136, and if the 3D printing head 13 moves toward the position of the impact mechanism 16 along the second direction, the trigger member 1351 is less likely to collide with the rod portion 1611. In other words, even if the 3D printing head moves toward the position of the impact mechanism 16 along the second direction, the avoidance groove 136 still provides a tolerance space for the 3D printing head and the impact mechanism. For example, in the event of a minor step loss of the 3D printing head, the avoidance groove can prevent the 3D printing head from colliding with the impact mechanism, thereby avoiding damage to the 3D printing head and the impact mechanism due to collision.

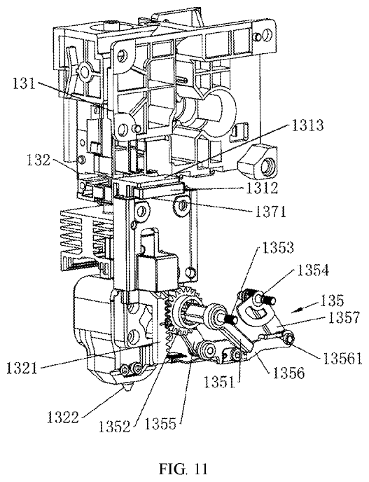

In a feasible implementation, referring to FIG. 11, the lifting mechanism 135 is connected to the first hot end assembly 132, the first hot end assembly 132 is spaced apart from the second hot end assembly 133, the second hot end assembly 133 is fixed to the connecting frame 131, and the lifting mechanism 135 is configured to drive the first hot end assembly 132 to move up and down. The first hot end assembly 132 moves up and down along the Z-axis direction. The lifting mechanism 135 drives the first hot end assembly 132 to move up and down, to change the height position of the first hot end assembly 132, thereby changing the relative height position between the first hot end assembly 132 and the second hot end assembly 133. In another feasible implementation, the lifting mechanism 135 is connected to the first hot end assembly 132, and the lifting mechanism 135 is further connected to the second hot end assembly 133. When the lifting mechanism 135 drives the first hot end assembly 132 to move up, the lifting mechanism 135 drives the second hot end assembly 133 to move down. When the lifting mechanism 135 drives the second hot end assembly 133 to move up, the lifting mechanism 135 drives the first hot end assembly 132 to move down. The first hot end assembly 132 and the second hot end assembly 133 may be respectively connected to two ends of the lifting mechanism 135.

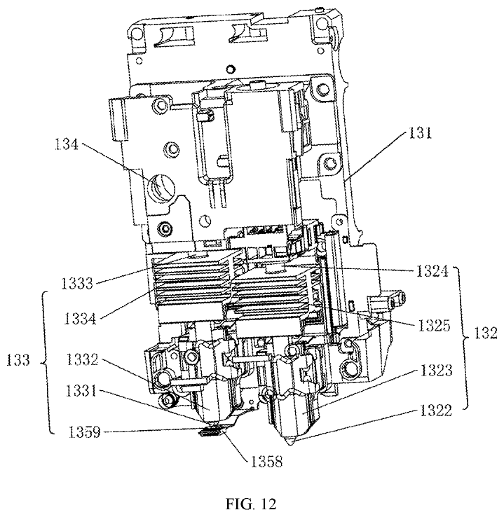

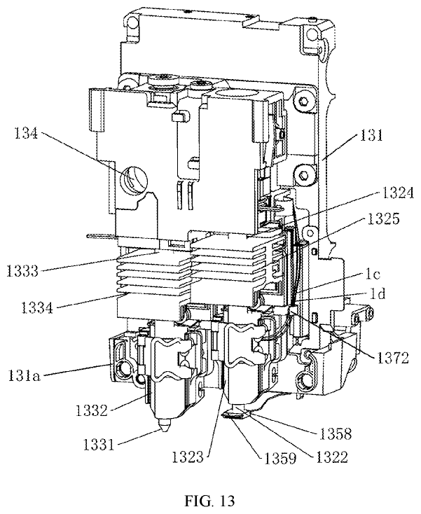

Referring to FIGS. 12 and 13, in the embodiments according to the present disclosure, the 3D printing head 13 further includes a connecting frame 131a detachably connected to the connecting frame 131, and the lifting mechanism 135 may be rotatably connected to the connecting frame 131a. The lifting mechanism 135 rotates relative to the connecting frame 131a to change the height positions of the first hot end assembly 132 and the second hot end assembly 133.

In the embodiments according to the present disclosure, during the lifting movement of the first hot end assembly 132, the movement trajectory of the first hot end assembly 132 includes a first position and a second position. The first position is lower than the second position. The first position may be the lowest position of the first hot end assembly 132 during the lifting movement. When the first hot end assembly 132 is located at the first position, the first hot end assembly 132 is configured to eject the printing material (the first filament 2) in a molten state. The second position may be the highest position of the first hot end assembly 132 during the lifting movement. When the second hot end assembly 133 is fixedly connected to the connecting frame 131, the first position is lower than the position of the second hot end assembly 133, and the second position is higher than the position of the second hot end assembly 133. When the first hot end assembly 132 is located at the second position, the second hot end assembly 133 is configured to eject the printing material (the second filament 3) in a molten state.

In some embodiments, with further reference to FIG. 11, the lifting mechanism 135 includes a gear 1352, the first hot end assembly 132 is fixedly connected to a rack 1321, and the gear 1352 meshes with the rack 1321. The lifting mechanism 135 further includes a first rotating shaft 1353, the trigger member 1351 includes a lever, the first rotating shaft 1353 passes through the gear 1352 and is fixed to the gear 1352, and the trigger member 1351 is fixedly connected to the first rotating shaft 1353. In one embodiment, one end of the lever is configured to be fixedly connected to the first rotating shaft 1353, and the other end of the lever is configured to collide with the contact member 161.

When the lever collides with the impact mechanism 16, the lever is actuated, and the lever drives, via the first rotating shaft 1353, the gear 1352 to rotate. During the rotation process, the gear 1352 drives the rack 1321 to move up and down, thereby driving the first hot end assembly 132 to move up and down.

In some embodiments, the lifting mechanism 135 includes a drive wheel, a driven wheel, and a conveyor belt. The drive wheel is connected to the trigger member 1351, the drive wheel is in transmission connection with the driven wheel via the conveyor belt, the trigger member 1351 collides with the impact mechanism 16, and the trigger member 1351 can drive the drive wheel to rotate and drive the conveyor belt to move up and down. The conveyor belt may be connected to the first hot end assembly 132 to drive the first hot end assembly 132 to move up and down.

In some embodiments, the lifting mechanism 135 may include a cam and a push rod. The cam may be hinged to the push rod, and one end of the push rod away from the cam is connected to the first hot end assembly 132. The cam is further connected to the trigger member 1351, and the trigger member 1351 collides with the impact mechanism 16 to drive the cam to rotate. When the cam rotates, the end of the push rod away from the cam can move linearly up and down, thereby driving the first hot end assembly 132 to move up and down.

In some embodiments, the first hot end assembly 132 is detachably connected to a first mounting position and a second mounting position of the connecting frame 131. When the first hot end assembly 132 is detachably connected to the first mounting position, the position of the first hot end assembly 132 is lower than the position of the second hot end assembly 133. When the first hot end assembly 132 is detachably connected to the second mounting position, the position of the first hot end assembly 132 is higher than the position of the second hot end assembly 133. When the first hot end assembly 132 is detachably connected to the first mounting position, the 3D printing head 13 may use the first hot end assembly 132 to eject the printing material (the first filament 2) in a molten state. When the first hot end assembly 132 is not mounted on the connecting frame 131 or is detachably connected to the second mounting position, the 3D printing head 13 may use the second hot end assembly 133 to eject the printing material (the second filament 3) in a molten state.

In some embodiments, referring to FIGS. 11, 12, and 13, the lifting mechanism 135 may include a gear 1352, a second rotating shaft 1354, a first connecting rod 1355, a second connecting rod 1356, and a third connecting rod 1357. The rack 1321 is fixed to the first hot end assembly 132, and the gear 1352 meshes with the rack 1321. The trigger member 1351 includes a lever. The first rotating shaft 1353 is spaced apart from the second rotating shaft 1354. A first end of the first connecting rod 1355 is hinged to the first rotating shaft 1353, a second end of the first connecting rod 1355 is hinged to a first end of the second connecting rod 1356, a second end of the second connecting rod 1356 is hinged to a first end of the third connecting rod 1357, and a second end of the third connecting rod 1357 is hinged to the second rotating shaft 1354. The first rotating shaft 1353 may be rotatably connected to the connecting frame 131a, and the second rotating shaft 1354 may be rotatably connected to the connecting frame 131a. The first rotating shaft 1353, the second rotating shaft 1354, the first connecting rod 1355, the second connecting rod 1356, and the third connecting rod 1357 may form a five-bar mechanism, which can limit the rotation angle of the gear 1352, improve the motion accuracy of the lifting mechanism 135, and make the rotation process of the gear 1352 more stable.

In some embodiments, the lifting mechanism 135 further includes a nozzle blocking sheet 1358, and the nozzle blocking sheet 1358 is connected to the second connecting rod 1356; the first hot end assembly 132 includes a first nozzle 1322 and a first heating block 1323, the first heating block 1323 is configured to heat the first filament 2 to a molten state, and the first nozzle 1322 is configured to eject the first filament 2 in a molten state; the second hot end assembly 133 includes a second nozzle 1331 and a second heating block 1332, the second heating block 1332 is configured to heat the second filament 3 to a molten state, and the second nozzle 1331 is configured to eject the second filament 3 in a molten state; the first nozzle 1322 is spaced apart from the second nozzle 1331; when the first hot end assembly 132 is located at the first position, the nozzle blocking sheet 1358 blocks the second nozzle 1331, and when the first hot end assembly 132 is located at the second position, the nozzle blocking sheet 1358 blocks the first nozzle 1322. The first hot end assembly 132 ejects the first filament 2 in a molten state onto the processing platform through the first nozzle 1322, and the second hot end assembly 133 ejects the second filament 3 in a molten state onto the processing platform through the second nozzle 1331. During the process in which the 3D printing head 13 switches the hot end assembly to eject the printing material, the lifting mechanism 135 moves and the position of the hot end assembly that needs to eject the printing material is lower than the position of the hot end assembly in the idle state (there is no need to eject the printing material). For example, in the 3D printing head 13, if the first hot end assembly 132 that needs to eject the printing material is switched to the second hot end assembly 133, the trigger member 1351 may be caused to collide with the impact mechanism 16, and the lifting mechanism 135 drives the first hot end assembly 132 to move up to the second position. In addition, the nozzle blocking sheet 1358 that moves along with the second connecting rod 1356 moves to a position below the first hot end assembly 132 and blocks the first hot end assembly 132. If the second hot end assembly 133 that needs to eject the printing material is switched to the first hot end assembly 132, the trigger member 1351 may be caused to collide with the impact mechanism 16, and the lifting mechanism 135 drives the first hot end assembly 132 to move down to the second position. In addition, the nozzle blocking sheet 1358 that moves along with the second connecting rod 1356 moves to a position below the second hot end assembly 133 and blocks the second hot end assembly 133.

In one embodiment, when the trigger member 1351 collides with the impact mechanism 16, the trigger member 1351 is actuated, thereby driving the first rotating shaft 1353 to rotate. The rotation of the first rotating shaft 1353 can drive the first connecting rod 1355 to swing, the swinging of the first connecting rod 1355 drives the second connecting rod 1356 to swing, and the swinging of the second connecting rod 1356 can drive the nozzle blocking sheet 1358 to move. In addition, the rotation of the first rotating shaft 1353 further drives the gear 1352 to rotate. The gear 1352 meshes with the rack 1321, and the gear 1352 drives the rack 1321 to move up and down along the Z-axis, thereby enabling the entire first hot end assembly 132 to move up and down. When the first hot end assembly 132 moves to the first position, the nozzle blocking sheet 1358 moves along with the second connecting rod 1356 to a position below the second nozzle 1331 and blocks the second nozzle 1331, thereby preventing the second nozzle 1331 from ejecting the second filament 3 in a molten state. When the first hot end assembly 132 moves to the second position, the nozzle blocking sheet 1358 moves along with the second connecting rod 1356 to a position below the first nozzle 1322 and blocks the first nozzle 1322, thereby preventing the first nozzle 1322 from ejecting the first filament 2 in a molten state.

A silicone sheet 1359 is provided on the upper surface of the nozzle blocking sheet 1358. When the first hot end assembly 132 is located at the first position, the silicone sheet 1359 is in contact with the second nozzle 1331. When the first hot end assembly 132 is located at the second position, the silicone sheet 1359 is in contact with the first nozzle 1322.

Illustratively, when the nozzle needs to be blocked, the silicone sheet 1359 may form a soft enclosure around the nozzle, and the silicone sheet 1359 can effectively block the nozzle. For example, when the first hot end assembly 132 is located at the first position, the silicone sheet 1359 is in contact with the second nozzle 1331, thereby effectively blocking the second nozzle 1331. When the first hot end assembly 132 is located at the second position, the silicone sheet 1359 is in contact with the first nozzle 1322, thereby effectively blocking the first nozzle 1322. In addition, the silicone sheet 1359 can provide soft contact between the nozzle blocking sheet and the nozzle to avoid damage to the nozzle due to excessive rigidity.

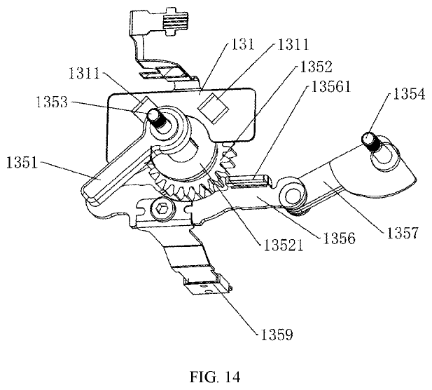

In the embodiments according to the present disclosure, referring to FIG. 14, the gear 1352 is provided with an annular magnet 13521, two sensors 1311 for detecting changes in the magnetic field are disposed on the connecting frame 131a, the two sensors 1311 are both located at the outer periphery of the annular magnet 13521, and the two sensors 1311 are arranged in a direction perpendicular to each other. The two sensors 1311 may be Hall sensors 1311. When the annular magnet 13521 rotates, the two sensors 1311 generate pulse signals due to changes in the magnetic field. Since the two Hall sensors 1311 are arranged at an angle of 90°, the two sensors 1311 may respectively sense the components of a rotating magnetic field in two orthogonal directions, and then the rotation angle of the gear 1352 is obtained through mathematical calculation (typically using the arc tangent function). Illustratively, the connecting frame 131a includes a circuit board, and the two sensors 1311 may be placed on the circuit board. Illustratively, the rotation angle of the gear 1352 can be obtained by the two sensors, to determine whether the first rotating shaft 1353 and the second rotating shaft 1354 rotate in place, thereby determining whether the first hot end assembly 132 and the second hot end assembly 133 are in proper positions.

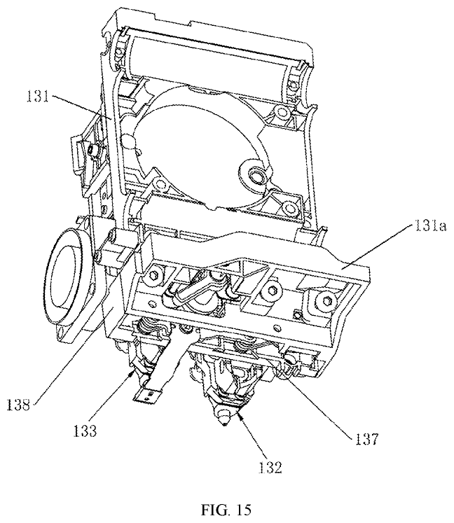

In some embodiments, referring to FIGS. 11 and 15, the 3D printing head 13 further includes a first base 137 detachably connected to the first hot end assembly 132, and the first base 137 is slidably connected to the connecting frame 131a; and/or the 3D printing head 13 further includes a second base 138 detachably connected to the second hot end assembly 133, and the second base 138 is fixedly connected to the connecting frame 131. The connecting frame 131a is movably connected to the first hot end assembly 132 via the first base 137, and the connecting frame 131a is detachably connected to the second hot end assembly 133 via the second base 138.

In one embodiment, one of the first base 137 and the connecting frame 131a is provided with a sliding rail 1312, and the other is provided with a sliding groove 1371. The sliding rail 1312 is in sliding fit with the sliding groove 1371.

In a feasible implementation, the first base 137 is provided with a sliding rail 1312, the connecting frame 131a is provided with a sliding groove 1371, and the sliding rail 1312 is in sliding fit with the sliding groove 1371. In another feasible implementation, the first base 137 is provided with a sliding groove 1371, the connecting frame 131a is provided with a sliding rail 1312, and the sliding rail 1312 is in sliding fit with the sliding groove 1371.

The connecting frame 131a is provided with an abutting member 1313, the abutting member 1313 is disposed above the first base 137, and the first base 137 movably abuts against the abutting member 1313. The abutting member 1313 is configured to limit the upper limit position of the first hot end assembly 132, and the upper limit position of the first hot end assembly 132 may be the second position.

At least one of the abutting member 1313 and the first base 137 is magnetic, and the other may have opposite magnetism or be made of metal, and the abutting member 1313 and the first base 137 attract each other. In one embodiment, when the first hot end assembly 132 is located at the second position, the abutting member 1313 is magnetically attracted to the first base 137, and the first hot end assembly 132 remains stable at the second position. In one embodiment, when the first hot end assembly is not yet fully in place (i.e., the first hot end assembly has not yet reached the second position), the abutting member 1313 can provide an attractive force to the first base 137, and the first base 137 can move into place. In the embodiments according to the present disclosure, during the process in which the trigger member 1351 collides with the impact mechanism 16 to move the first hot end assembly 132 from the second position to the first position, the trigger member 1351 is in contact with the contact region 16111 of the rod portion 1611 in the impact mechanism 16. Since the position of the contact region 16111 is lower than the position of the central axis of the rod portion 1611, the impact mechanism 16 can exert a force with a downward component on the trigger member 1351, overcoming the stable state of the first hot end assembly 132 at the second position and performing work, thereby enabling the first hot end assembly 132 to switch from the second position to the first position.

The abutting member 1313 is magnetic, the first base 137 is magnetic, and the magnetism of one side of the abutting member 1313 facing the first base 137 is different from the magnetism of one side of the first base 137 facing the abutting member 1313. In one embodiment, one of the abutting member 1313 and the first base 137 is magnetic, and the other is made of metal. If one of the abutting member 1313 and the first base 137 is made of metal, the metal may be iron, an iron-containing alloy, nickel, a nickel-containing alloy, cobalt, a cobalt-containing alloy, or the like.

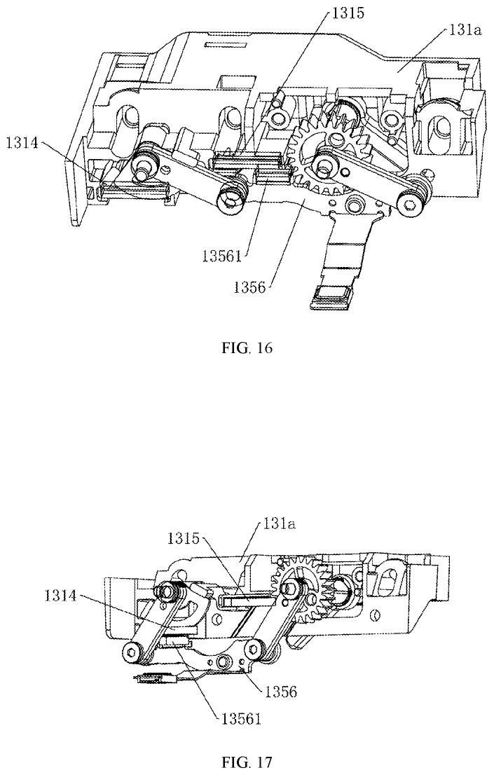

Referring to FIGS. 16 and 17, the connecting frame 131a is provided with a first magnet 1314 and a second magnet 1315. The second connecting rod 1356 is provided with a third magnet 13561 or a metal. When the first hot end assembly 132 is located at the first position, the second magnet 1315 is magnetically attracted to the third magnet 13561 or the metal of the second connecting rod 1356, which enables the first hot end assembly 132 to remain stable at the first position, thereby facilitating the ejection of a filament in a molten state by the first hot end assembly 132 in a stable state. When a first hot end assembly is located at the second position, the first magnet 1314 is magnetically attracted to the third magnet 13561 or the metal of the second connecting rod 1356, and the first hot end assembly 132 remains stable at the second position. When the second hot end assembly 133 ejects the second filament 3 in a molten state, the first hot end assembly 132 can be prevented from downward movement and interference with the product, which would otherwise affect the process of processing the product.

In some embodiments, the nozzle blocking sheet 1358 and the third magnet 13561 are located on two opposite sides of the second connecting rod 1356, respectively. The third magnet 13561 is closer to the connecting frame 131a in the Z-axis direction than the nozzle blocking sheet 1358.

In some embodiments, referring to FIG. 13, the first base 137 is connected to at least one of a power cable 1c and a signal cable 1d; the first base 137 is provided with a cable tie 1372, and the cable tie 1372 is configured to fix at least one of the power cable 1c and the signal cable 1d. The cable tie 1372 can secure the power cable 1c and the signal cable 1d, thereby preventing entanglement between the power cable 1c and the signal cable 1d. When the first hot end assembly 132 moves up and down, the power cable 1c and the signal cable 1d move up and down along with the first base 137. This prevents the first hot end assembly 132 from pulling the power cable 1c or the signal cable 1d during the lifting process, which would otherwise damage the power cable 1c or the signal cable 1d.

In the embodiments according to the present disclosure, referring to FIGS. 2 and 18, the 3D printing head 13 further includes an extrusion front casing 139, and the extrusion front casing 139 is detachably connected to the connecting frame 131.

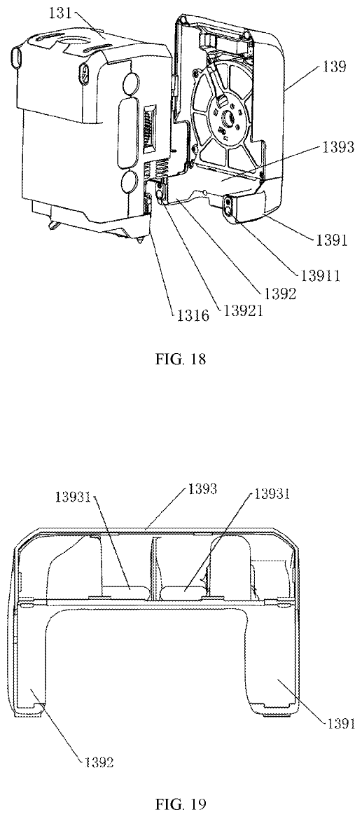

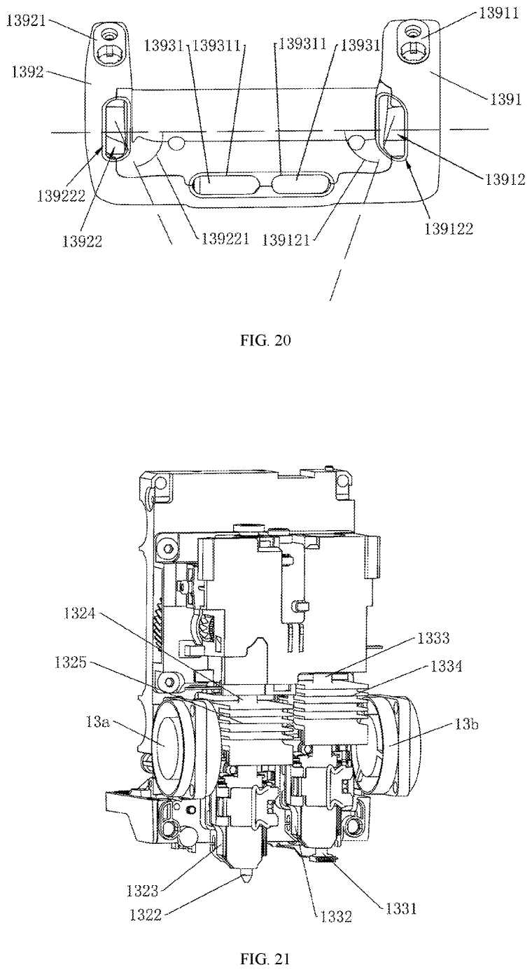

Referring to FIGS. 19 and 20, the extrusion front casing 139 includes a first portion 1391, a second portion 1392, and a third portion 1393. The first portion 1391 is spaced apart from the second portion 1392 in a width direction (e.g., the X-axis direction) of the 3D printing head 13, the third portion 1393 connects the first portion 1391 and the second portion 1392, the first hot end assembly 132 is spaced apart from the second hot end assembly 133, and the first portion 1391 and the second portion 1392 are respectively located on two opposite sides between the first hot end assembly 132 and the second hot end assembly 133.

In the depth direction (e.g., the Y-axis direction) of the 3D printing head 13, the first portion 1391 and the second portion 1392 are located on the same side of the third portion 1393. One side of the first portion 1391 facing away from the third portion 1393 is provided with a first magnetic attraction member 13911, and one side of the second portion 1392 facing away from the third portion 1393 is provided with a second magnetic attraction member 13921.

The connecting frame 131 is provided with a third magnetic attraction member 1316 and a fourth magnetic attraction member 1317. The first magnetic attraction member 13911 is attracted to the third magnetic attraction member 1316, and the second magnetic attraction member 13921 is attracted to the fourth magnetic attraction member 1317.

The extrusion front casing 139 is magnetically engaged with the connecting frame 131, and the extrusion front casing 139 can be easily mounted on the connecting frame 131, and the extrusion front casing 139 can also be easily detached from the connecting frame 131.

The extrusion front casing 139 is magnetically engaged with the connecting frame 131. By measuring the magnetic field intensity generated by the first magnetic attraction member 13911 and the second magnetic attraction member 13921 in the extrusion front casing 139 through Hall detection, it can be determined whether the extrusion front casing 139 is mounted in place (mounted to the connecting frame 131).

The first portion 1391 is provided with a first air duct 13912 that penetrates through the first portion 1391 in a height direction (Z-axis direction) of the 3D printing head 13, and the first air duct 13912 is provided with a first air outlet 139122. The second portion 1392 is provided with a second air duct 13922 that penetrates through the second portion 1392 in the height direction of the 3D printing head 13, and the second air duct 13922 is provided with a second air outlet 139222.

A first included angle 139121 is formed between the orientation of the first air outlet 139122 and the width direction of the 3D printing head 13, a second included angle 139221 is formed between the orientation of the second air outlet 139222 and the direction opposite to the width direction of the 3D printing head 13, and the first included angle 139121 is different from the second included angle 139221.

In the embodiments according to the present disclosure, the height position of the first hot end assembly 132 when ejecting the first filament 2 is different from the height position of the second hot end assembly 133 when ejecting the second filament. The height position of the first hot end assembly 132 when ejecting the first filament 2 in a molten state is the first position, and the height of the first position is lower than the height of the second hot end assembly 133. When the second hot end assembly 133 ejects the second filament 3 in a molten state, the position of the first hot end assembly 132 is the second position, and the second position is the highest position to which the first hot end assembly 132 can rise under the driving of the lifting mechanism 135. The second position is higher than the position of the second hot end assembly 133.

The airflow flowing through the first air duct 13912 can cool the filament ejected by the first hot end assembly 132, and the airflow flowing through the second air duct 13922 can cool the filament ejected by the second hot end assembly 133, thereby facilitating the rapid cooling, solidification, and formation of the three-dimensional product.

In the width direction of the 3D printing head 13, the width direction of the 3D printing head 13 may be parallel to the X-axis direction. The first hot end assembly 132 is located between the first portion 1391 and the second portion 1392, and the second hot end assembly 133 is located between the first portion 1391 and the second portion 1392. The first air outlet 139122 faces the first hot end assembly 132, and the second air outlet 139222 faces the second hot end assembly 133. The airflow flowing out of the first air outlet 139122 is configured to accelerate the cooling of a product formed by the printing material ejected from the first hot end assembly 132, and the airflow flowing out of the second air outlet 139222 is configured to accelerate the cooling of a product formed by the printing material ejected from the second hot end assembly 133, thereby accelerating the solidification of the product. In one embodiment, the second air outlet 139222 faces the second nozzle 1331. When the first hot end assembly 132 is located at the first position, the first air outlet 139122 faces the first nozzle 1322.

The third portion 1393 is provided with a third air duct 13931 that penetrates through the third portion 1393 in the height direction of the 3D printing head 13, the height direction of the 3D printing head 13 is parallel to the Z-axis direction, and the third portion 1393 is provided with a third air duct 13931 that penetrates through the third portion 1393 in the height direction of the 3D printing head 13. The third air duct 13931 can also be used to cool the printing material in a molten state ejected from the first nozzle 1322. The third air duct 13931 can also be used to cool the printing material in a molten state ejected from the second nozzle 1331. A plurality of third air ducts 13931 may be provided, each third air duct 13931 is provided with a third air outlet 139311, and the plurality of third air ducts 13931 may be arranged in the width direction of the 3D printing head 13.

On a projection in the depth direction of the 3D printing head 13, the depth direction of the 3D printing head 13 is parallel to the Y-axis direction, and the third air outlet 139311 is located between the first air outlet 139122 and the second air outlet 139222. The first air outlet 139122, the second air outlet 139222, and the third air outlet 139311 partially surround the first nozzle 1322, and the cooling effect of the first nozzle 1322 can be improved. The first air outlet 139122, the second air outlet 139222, and the third air outlet 139311 partially surround the second nozzle 1331, and the cooling effect of the second nozzle 1331 can be improved.

A first fan 1394 is mounted on the extrusion front casing 139. The first fan 1394 is configured to supply airflow to the first air duct 13912, the second air duct 13922, and the third air duct 13931. The first air duct 13912, the second air duct 13922, and the third air duct 13931 may share one first fan 1394.

The airflow generated by the first fan 1394 can pass through the first air duct 13912 to cool the printing material in a molten state ejected from the first nozzle 1322. The airflow generated by the first fan 1394 can also pass through the first air duct 13912 to cool the printing material in a molten state ejected from the second nozzle 1331. The airflow generated by the first fan 1394 can pass through the second air duct 13922 to cool the printing material in a molten state ejected from the first nozzle 1322. The airflow generated by the first fan 1394 can pass through the second air duct 13922 to cool the printing material in a molten state ejected from the second nozzle 1331. The airflow generated by the first fan 1394 can pass through the third air duct 13931 to cool the printing material in a molten state ejected from the first nozzle 1322. The airflow generated by the first fan 1394 can pass through the third air duct 13931 to cool the printing material in a molten state ejected from the second nozzle 1331.

In one embodiment, the first fan 1394 is located on one side of the first air duct 13912 away from the first air outlet 139122, the first fan 1394 is located on one side of the second air duct 13922 away from the second air outlet 139222, the third air duct 13931 is provided with a third air outlet 139311, and the first fan 1394 is located on one side of the third air duct 13931 away from the third air outlet 139311.

In the 3D printing head 13 according to the present disclosure, referring to FIG. 21, the first hot end assembly 132 further includes a first filament feed channel 1324 and a first heat dissipation fin 1325 disposed below or on the periphery of the first filament feed channel 1324. The first heating block 1323 is connected between the first filament feed channel 1324 and the first nozzle 1322. The 3D printing head 13 further includes a second fan 13a, and the second fan 13a blows air toward the first heat dissipation fin 1325. The first filament feed channel 1324 is configured to allow the first filament 2 to pass through and extend into the position of the first heating block 1323. The first heating block 1323 heats the first filament 2 to a molten state, and the first nozzle 1322 ejects the first filament 2 in a molten state onto the processing platform. While heating the first filament 2, the first heating block 1323 also transfers heat to the first filament feed channel 1324. To prevent the temperature of the first filament feed channel 1324 from becoming too high and causing the first filament 2 to soften, the second fan 13a is used to blow air toward the first heat dissipation fin 1325, and the first heat dissipation fin 1325 can quickly dissipate the heat, thereby rapidly reducing the temperature of the first filament feed channel 1324 through the first heat dissipation fin 1325. If the temperature of the first filament feed channel 1324 is too high and causes the first filament 2 to soften prematurely, the conveyance of the first filament 2 is not facilitated, and the first filament feed channel 1324 is prone to blockage.

The second hot end assembly 133 further includes a second filament feed channel 1333 and a second heat dissipation fin 1334 disposed below or on the periphery of the second filament feed channel 1333. The second heating block 1332 is connected between the second filament feed channel 1333 and the second nozzle 1331. The 3D printing head 13 further includes a third fan 13b, and the third fan 13b blows air toward the second heat dissipation fin 1334. The second filament feed channel 1333 is configured to allow the second filament 3 to pass through and extend into the position of the second heating block 1332. The second heating block 1332 heats the second filament 3 to a molten state, and the second nozzle 1331 ejects the second filament 3 in a molten state onto the processing platform. While heating the second filament 3, the second heating block 1332 also transfers heat to the second filament feed channel 1333. To prevent the temperature of the second filament feed channel 1333 from becoming too high and causing the second filament 3 to soften prematurely, the second fan 13a is used to blow air toward the second heat dissipation fin 1334, and the second heat dissipation fin 1334 can quickly dissipate the heat, thereby rapidly reducing the temperature of the second filament feed channel 1333 through the second heat dissipation fin 1334. If the temperature of the second filament feed channel 1333 is too high and causes the second filament 3 to soften prematurely, the conveyance of the second filament 3 is not facilitated, and the first filament feed channel 1324 is prone to blockage.

In the embodiments according to the present disclosure, the housing 15 surrounds and forms a build space. In one embodiment, the housing 15 may further include a frame 152, and the frame 152 is connected to the base 151. The 3D printing head 13 and the guide member 14 are disposed in the build space. The guide member 14 is connected to the housing 15, and the first extrusion assembly 11 is detachably disposed on the housing 15. The guide member 14 is, in one embodiment, connected to the frame 152.

The 3D printer 1 may be of a core xy structure. The guide member 14 is supported by the frame 152 on the 3D printer 1, the 3D printing head 13 can move on an XY plane along the guide member 14 under the drive of a belt, and the processing platform is connected to a Z-axis lead screw to achieve movement in the Z-axis direction. Illustratively, the guide member 14 may be at least one of a Y-axis rail, a carbon rod, and an X-axis linear shaft. In one embodiment, the 3D printer 1 may also be of a cantilever structure. The guide member 14 is supported by a Z-axis column, the guide member 14 moves up and down along the Z-axis, the 3D printing head 13 may move along the guide member 14 in the Y-axis direction, and the processing platform moves in the X-axis direction.

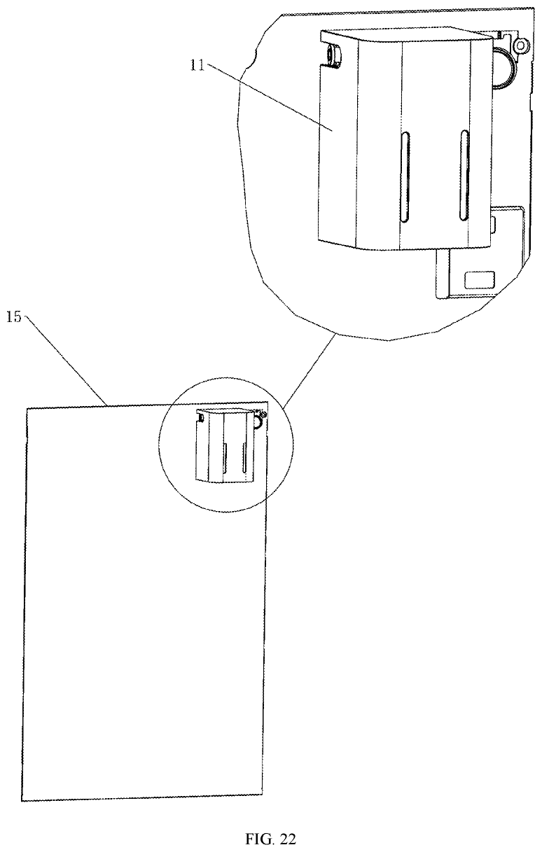

In one embodiment, referring to FIG. 22, the first extrusion assembly 11 is detachably disposed on one side of the housing 15 facing away from the 3D printing head 13. The first extrusion assembly 11 does not occupy the build space surrounded by the housing 15, thereby reducing the overall volume of the 3D printer 1. The first extrusion assembly 11 is configured to be detachable, which facilitates the assembly and maintenance of the 3D printer.

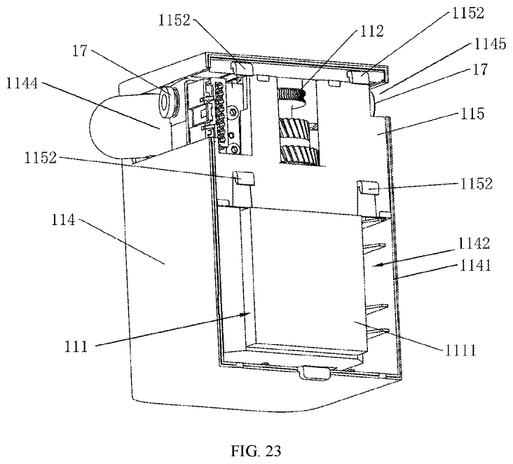

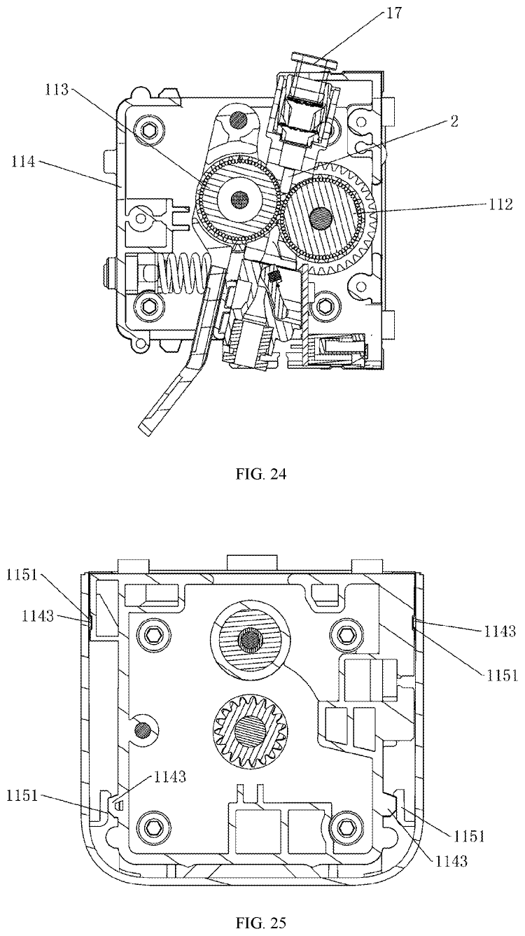

In the embodiments according to the present disclosure, referring to FIGS. 23 and 24, the first extrusion assembly 11 further includes a casing 114 and a mounting base 115. The casing 114 is detachably connected to the housing 15, and the mounting base 115 is detachably connected to the housing 15. The extrusion wheel 112 and the extrusion wheel 113 are disposed on the mounting base 115, the casing 114 accommodates the mounting base 115, and the casing 114 is detachably connected to the mounting base 115. The casing 114 defines, in an enclosing manner, an accommodating space 1142 with an opening 1141, and the first motor 111, the extrusion wheel 112, the extrusion wheel 113, and the mounting base 115 are all accommodated in the accommodating space 1142.

The casing 114 defines, in an enclosing manner, an accommodating space 1142 with an opening 1141. The accommodating space 1142 accommodates the first motor 111, the extrusion wheel 112, the extrusion wheel 113, and the mounting base 115. The arrangement of the opening 1141 can facilitate the disassembly and assembly of the first extrusion assembly 11, and the opening 1141 can also facilitate the heat dissipation of the first motor 111. The casing 114 can protect the first motor 111, the extrusion wheel 112, and the extrusion wheel 113, and can prevent dust from entering the accommodating space 1142.

The mounting base 115 is connected to the casing 114, the extrusion wheel 112, and the extrusion wheel 113. The mounting base 115 is also connected to the housing 15, and the mounting base 115 can serve a load-bearing function.

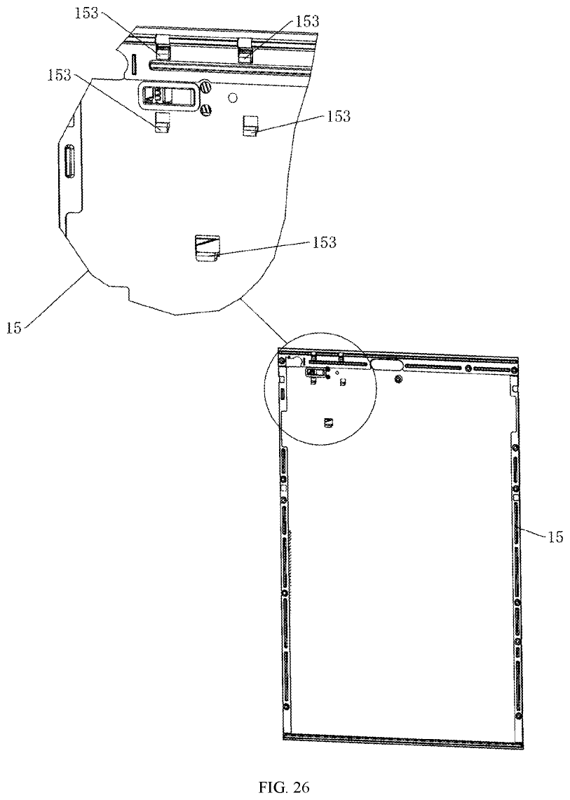

Referring to FIG. 25, the casing 114 is snap-fitted to the mounting base 115. One of the mounting base 115 and the inner wall surface of the casing 114 is provided with a first protrusion 1143, the other is provided with a first groove 1151, and the first protrusion 1143 extends into the first groove 1151. When the casing 114 is snap-fitted to the mounting base 115, the presence of the opening 1141 in the casing 114 enables the casing 114 to have certain deformation capability, thereby facilitating the snap-fit engagement between the casing 114 and the mounting base 115.

In the embodiments according to the present disclosure, the casing 114 is provided with a first notch 1144 and a second notch 1145 on two opposite sides in the conveying direction of the first filament 2, respectively. The first notch 1144 is in communication with the accommodating space 1142, and the second notch 1145 is in communication with the accommodating space 1142. The arrangement of the first notch 1144 and the second notch 1145 is conducive to improving the deformation capability of the casing 114.

During the process in which the first extrusion assembly 11 conveys the first filament 2 to the first hot end assembly 132, the first filament 2 is released by the feeding device, and the first filament 2 passes through the first extrusion assembly 11 and extends to the first hot end assembly 132. The first filament 2 extends from the first notch 1144 into the casing 114, passes through a gap between the outer peripheral surface of the extrusion wheel 112 and the outer peripheral surface of the extrusion wheel 113, and extends out of the first extrusion assembly 11 from the second notch 1145. The first notch 1144, the second notch 1145, and the opening 1141 are located on different sides of the casing 114.

In the embodiments according to the present disclosure, referring to FIGS. 1 and 25, the 3D printer 1 further includes a first filament tube connector 17. The first notch 1144 and/or the second notch 1145 allows the first filament tube connector 17 to pass through, and the first filament tube connector 17 is configured to connect the first filament tube 1a, and the first filament 2 can pass through the first filament tube 1a. The first filament tube connector 17 may be connected to the mounting base 115. Two first filament tube connectors 17 may be provided. One of the two first filament tube connectors 17 passes through the first notch 1144 and is connected to the mounting base 115, and the other of the two first filament tube connectors 17 passes through the second notch 1145 and is connected to the mounting base 115. The first filament tube connector 17 can allow the first filament 2 to pass through, and the other of the two first filament tube connectors 17 may also pass through the housing 15 and extend into the housing 15.

In the embodiments according to the present disclosure, a section of first filament tube 1a is connected between the feeding device and the first extrusion assembly 11; one end of this section of first filament tube 1a may be connected to the first filament tube connector 17 that passes through the first notch 1144, and the other end of this section of first filament tube 1a may be connected to the filament tube connector on the feeding device. Another section of first filament tube 1a may be disposed between the first extrusion assembly 11 and the first hot end assembly 132; one end of the another section of first filament tube 1a may be connected to the first filament tube connector 17 that passes through the second notch 1145, and the other end of the another section of first filament tube 1a may be connected to the feeding port of the first hot end assembly 132.

In the embodiments according to the present disclosure, the surface of the first motor 111 is provided with a heat dissipation member 1111, and the first motor 111 is in contact with the outer wall of the housing 15 through the heat dissipation member 1111. The heat dissipation member 1111 exhibits good thermal conductivity, and the housing 15 is a metal housing 15. The heat dissipation member 1111 can pass through the opening 1141 to directly come into contact with the metal housing 15. The direct contact between the heat dissipation member 1111 and the metal housing 15 facilitates the heat dissipation of the first motor 111 and prolongs the service life of the first motor 111.

In the embodiments according to the present disclosure, referring to FIG. 26, the surface of the mounting base 115 facing the opening 1141 is provided with a snap-fit portion 1152, the outer wall of the housing 15 is provided with a snap-fit mating portion 153, and the snap-fit portion 1152 is snap-fitted to the snap-fit mating portion 153. The mounting base 115 can be conveniently mounted on the housing 15 or detached from the housing 15. At least part of the snap-fit portion 1152 may be located at a position of the mounting base 115 close to the edge of the casing 114, and at least part of the snap-fit mating portion 153 may be located at a position of the housing 15 close to the edge of the housing 15. When the first extrusion assembly 11 is mounted on the housing 15, the snap-fit mating portion 153 near the edge of the housing 15 cooperates with the snap-fit portion 1152 of the mounting base 115 near the casing 114. This can reduce the gap between the region near the edge of the housing 15 and the region near the edge of the casing 114, improve the aesthetic cooperation between the first extrusion assembly 11 and the housing 15, ensure the attachment between the motor and the housing, and assist in the heat dissipation of the motor.

The first extrusion assembly 11 is mounted on the outer wall surface of the housing 15, and the outer wall surface of the housing 15 has a relatively large area and often has poor flatness. If the snap-fit portion 1152 is not provided at a position of the mounting base 115 close to the edge of the casing 114, and/or the snap-fit mating portion 153 is not provided near the edge of the housing 15, when the mounting base 115 is snap-fitted to the housing 15, a large gap easily occurs between the edge of the mounting base 115 close to the casing 114 and the edge of the housing 15, which degrades the aesthetic cooperation between the mounting base 115 and the housing 15.

In some embodiments, referring to FIGS. 1 and 26, the 3D printer 1 further includes a second filament tube connector 18. The second filament tube connector 18 is detachably provided in the housing 15 in a penetrating manner. One end of the second filament tube connector 18 is located within the housing 15, and the other end of the second filament tube connector 18 extends out of the housing 15. A second filament tube 1b is connected between the second filament tube connector 18 and the second extrusion assembly 134, and the second filament tube 1b is configured to allow the second filament 3 to pass through.

One end of the second filament tube connector 18 extending out of the housing 15 is also connected to the feeding device via a section of second filament tube 1b, and the first filament tube connector 17 allows the second filament 3 to pass through. In one embodiment, the feeding device releases the second filament 3, and the second filament 3 passes through the second filament tube connector 18 and extends to the second extrusion assembly 134. The second extrusion assembly 134 can drive the second filament 3 to move linearly, thereby conveying the second filament 3 to the second hot end assembly 133.

The axial direction of the second filament tube connector 18 may be arranged parallel to the axial direction of the first filament tube connector 17, and the extension angle at which the first filament 2 extends from the outside of the housing 15 into the housing 15 may be the same as the extension angle at which the second filament 3 extends from the first extrusion assembly 11 into the housing 15. The extension angle of the first filament 2 extending from the outside of the housing 15 into the housing 15 refers to an included angle formed between the first filament 2 and the outer wall surface of the housing 15 when the first filament passes through the housing 15, and the extension angle of the second filament 3 extending from the first extrusion assembly 11 into the housing 15 refers to an included angle formed between the second filament 3 and the outer wall surface of the housing 15 when the second filament passes through the housing 15. The resistance experienced by the feeding device when releasing the first filament 2 and the second filament 3 is substantially the same, which facilitates the control over the force for releasing the first filament 2 and the second filament 3 by the feeding device. To reduce the friction force between the first filament tube 1a and the first filament 2 in the housing 15, the first filament tube 1a in the housing 15 is not prone to excessive bending. Similarly, in order to reduce the frictional force between the second filament tube 1b and the second filament 3 in the housing 15, the second filament tube 1b in the housing 15 is not prone to excessive bending. In general, the first filament tube 1a and the second filament tube 1b are respectively connected to the first hot end assembly 132 and the second extrusion assembly 134 along the extending direction of the drag chain 1e. The axial direction of the second filament tube connector 18 may be arranged parallel to the axial direction of the first filament tube connector 17, and the first filament tube 1a and the second filament tube 1b in the housing 15 tend to be parallel to each other. The first filament tube 1a in the housing 15 and the second filament tube 1b in the housing 15 may share the same drag chain 1e. The drag chain 1e can protect the first filament tube 1a, the second filament tube 1b, the power cable 1c, the signal cable 1d, and the like. The drag chain 1e can limit the first filament tube 1a, the second filament tube 1b, the power cable 1c, and the signal cable 1d. During the movement of the 3D printing head 13, the drag chain 1e can prevent excessive stretching of the first filament tube 1a, the second filament tube 1b, the power cable 1c, and the signal cable 1d, and the drag chain 1e can also enable the first filament tube 1a, the second filament tube 1b, the power cable 1c, and the signal cable 1d to be arranged in an orderly manner, thereby avoiding the risk of entanglement.

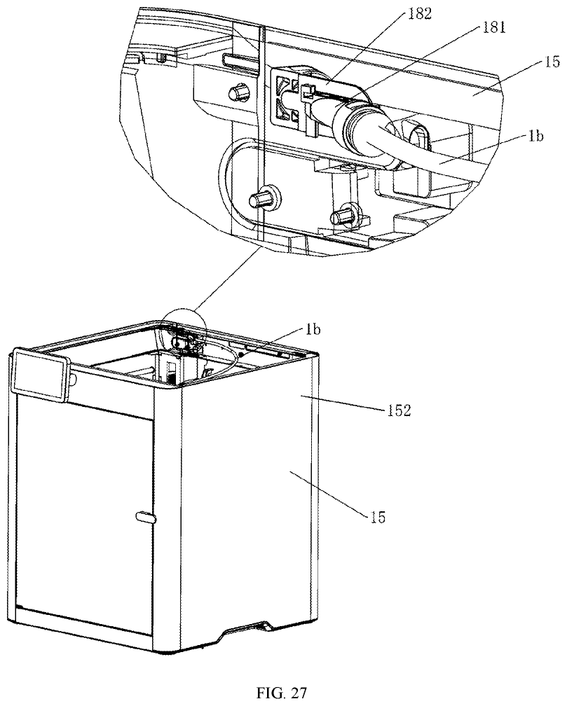

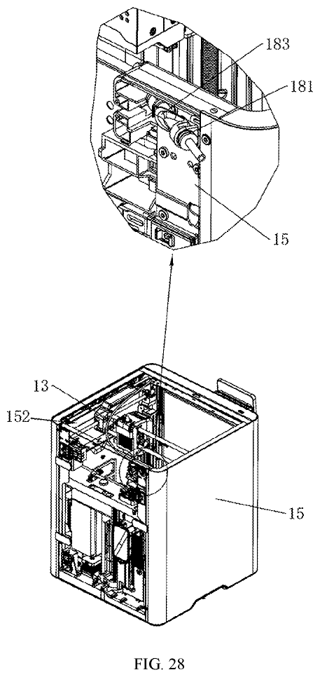

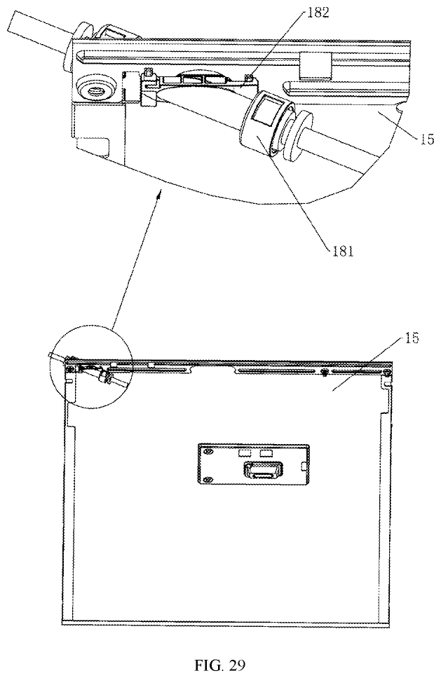

In the embodiments according to the present disclosure, referring to FIGS. 27, 28, and 29, the included angle between the first filament tube connector 17 and/or the second filament tube connector 18 and the outer wall surface of the housing 15 is within a range of 25° to 40°. The 3D printing head 13 needs to move in the housing 15 along the first direction or the second direction, and sufficient length needs to be reserved for the first filament tube 1a and the second filament tube 1b in the housing 15 to prevent the first filament tube 1a and/or the second filament tube 1b from being straightened during the movement of the 3D printing head 13. By allowing the included angle between the first filament tube connector 17 and/or the second filament tube connector 18 and the outer wall surface of the housing 15 to be within the range of 25° to 40°, the curvature of the first filament tube 1a connected between the first filament tube connector 17 and the first hot end assembly 132 in the housing 15 can be kept relatively low, and the curvature of the second filament tube 1b connected between the second filament tube connector 18 and the second extrusion assembly 134 in the housing 15 can also be kept relatively low, thereby reducing the frictional force between the first filament 2 and the first filament tube 1a, and further reducing the friction force between the second filament 3 and the second filament tube 1b.

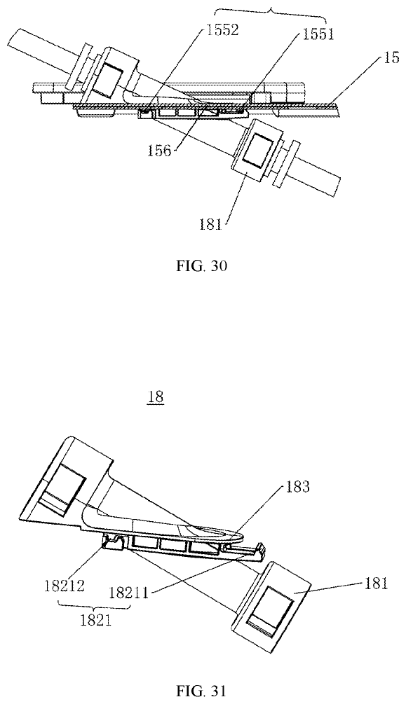

Referring to FIGS. 30 and 31, the second filament tube connector 18 includes a main body portion 181 and a connecting portion 182. The connecting portion 182 surrounds the main body portion 181 and is connected to the main body portion 181, and the main body portion 181 is configured to allow the second filament 3 to pass through. The housing 15 is further provided with a through hole 154 for the connecting portion 182 to extend into, the inner wall of the housing 15 where the through hole 154 is located is provided with a limiting portion 155, and a part of the connecting portion 182 that extends into the housing 15 via the through hole 154 is provided with a limiting mating portion 1821 cooperating with the limiting portion 155.

The limiting portion 155 cooperates with the limiting mating portion 1821 to limit the second filament tube connector 18 to an extent, thereby enabling a relatively stable connection state between the second filament tube connector 18 and the housing 15. However, when a user actively pulls the second filament tube connector 18, the second filament tube connector 18 can be easily pulled out of the through hole 154, allowing the second filament tube connector 18 to be quickly detached from the housing 15.

A functional component 19 of the 3D printer 1 is fixedly provided on one side, facing the build space, of the housing 15 where the through hole 154 is located. The functional component 19 includes at least one of a timing belt motor, a filter fan, a heating fan, and a cooling fan.

To achieve a more compact structure of the 3D printer 1 and properly utilize the space surrounded by the housing 15, the functional component 19 fixed to the housing 15 is located relatively close to the through hole 154. If the second filament tube connector 18 is also fixedly connected to the housing 15, it is not conducive to the mounting and maintenance of the second filament tube connector 18. In the embodiments according to the present disclosure, the second filament tube connector 18 is detachably connected to the housing 15, and the second filament tube connector 18 can be quickly detached from the housing 15, which facilitates the mounting or maintenance of the second filament tube connector 18.

The limiting portion 155 includes a second protrusion 1551, the second protrusion 1551 is located on one side of the through hole 154, the limiting mating portion 1821 includes a hook portion 18211, and the hook portion 18211 is in contact with one side of the second protrusion 1551 away from the through hole 154.

In the embodiments according to the present disclosure, the connecting portion 182 extends into the housing 15 from the through hole 154, the hook portion 18211 of the connecting portion 182 can hook the second protrusion 1551, and the second filament tube connector 18 and the housing 15 can maintain a stable connection. The perpendicular distance between the surface of the second protrusion 1551 away from the housing 15 and the surface of the hook portion 18211 close to the housing 15 ranges from 0.49 mm to 0.61 mm. When the second filament tube connector 18 is subjected to an external force (e.g., the user pulls the second filament tube connector 18), the second filament tube connector 18 can be easily pulled out of the through hole 154.

The limiting portion 155 includes a third protrusion 1552, the third protrusion 1552 is located on one side of the through hole 154, and the arrangement direction of the through hole 154 and the second protrusion 1551 is perpendicular to the arrangement direction of the through hole 154 and the third protrusion 1552. The limiting mating portion 1821 includes a second groove 18212, and the third protrusion 1552 extends into the second groove 18212. The extension of the third protrusion 1552 into the second groove 18212 provides a tactile in-place feedback when the second filament tube connector 18 extends into the through hole 154 and is mounted in place, thereby helping the user to determine whether the second filament tube connector 18 is mounted in place during the mounting of the second filament tube connector 18.

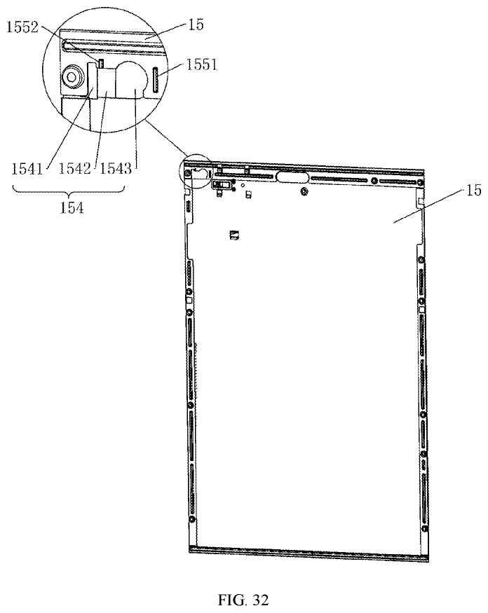

In the embodiments according to the present disclosure, referring to FIG. 32, the through hole 154 includes a first section 1541, a second section 1542, and a third section 1543 arranged in sequence. The second section 1542 is located between the first section 1541 and the third section 1543, and the second protrusion 1551 is located on one side of the third section 1543 away from the second end.

In the arrangement direction of the through hole 154 and the third protrusion 1552, the dimension of the first section 1541 is greater than the dimension of the second section 1542, the dimension of the third section 1543 is greater than the dimension of the second section 1542, and the third protrusion 1552 is located on one side of the second section 1542. The second filament tube connector 18 may extend from the third section 1543 into the housing 15. In the arrangement direction of the through hole 154 and the third protrusion 1552, the dimension of the second section 1542 is smaller than the dimension of the third section 1543, the third protrusion 1552 is located on one side of the second section 1542, and the third protrusion 1552 engages with the second groove 18212 of the connecting portion 182, which can limit the connector.

The outer wall of the housing 15 where the through hole 154 is located is provided with a limiting groove 156, and the limiting groove 156 surrounds the through hole 154. The second filament tube connector 18 further includes a stopping portion 183, the stopping portion 183 surrounds the main body portion 181 and is connected to the main body portion 181, and the stopping portion 183 is in contact with a groove bottom surface of the limiting groove 156.

The bottom wall of the limiting groove 156 cooperates with the stopping portion 183 to limit the second filament tube connector 18 in a direction in which the second filament tube connector 18 extends into the housing 15, and the limiting groove 156 can prevent the stopping portion 183 from extending into the through hole 154.

All directional indications (such as up, down, left, right, front, and back) in the embodiments of the present disclosure are only used to explain the relative positional relationships, movement conditions, etc., between components under a specific posture (as shown in the figures). If this specific posture changes, the directional indications will also change accordingly.

In addition, the descriptions involving “first”, “second”, etc., in the present disclosure are solely for descriptive purposes and should not be understood as indicating or implying relative importance or implicitly specifying the number of the technical features being indicated. Thus, features defined by “first” and “second” may explicitly or implicitly include at least one such feature. In the description of the present disclosure, the term “plurality/multiple” means at least two, such as two or three, unless otherwise explicitly and, in one embodiment, defined.

In the present disclosure, unless otherwise expressly specified and defined, terms such as “connected” and “fixed” should be understood in a broad sense. For example, “fixed” may refer to a fixed connection, a detachable connection, or an integral formation; and “connected” may refer to a mechanical connection or an electrical connection; a direct connection or an indirect connection through an intermediate medium; an internal communication between two elements or an interaction between two elements, unless otherwise expressly defined. For those of ordinary skill in the art, the specific meanings of the above terms in the present disclosure can be interpreted according to specific conditions.

In addition, the embodiments of the present disclosure may be combined with each other, but such combinations must be based on the premise that they can be realized in the art. If the combination of some embodiments results in contradictions or infeasibility, it should be considered that the combination does not exist and is not within the protection scope of the present disclosure.

The above descriptions are specific embodiments of the present disclosure. However, the protection scope of the present disclosure is not limited to this. Any variations or substitutions that those skilled in the art can easily think of within the technical scope disclosed in the present disclosure should be included within the protection scope of the present disclosure. Therefore, the protection scope of the present disclosure should be subject to the protection scope defined by the claims.

What is claimed is:

1. A 3D printer, comprising a first extrusion assembly, a driving member, a guide member, and a 3D printing head, wherein the first extrusion assembly is spaced apart from the 3D printing head; the 3D printing head is slidably connected to the guide member, and the driving member is in transmission connection with the 3D printing head;
the 3D printing head comprises a connecting frame, a first hot end assembly, a second hot end assembly, and a second extrusion assembly, wherein the first hot end assembly, the second hot end assembly, and the second extrusion assembly are connected to the connecting frame; the first extrusion assembly is configured to drive a first filament so as to convey the first filament to the first hot end assembly;
the first extrusion assembly comprises a first motor and two extrusion wheels, wherein the first motor is in transmission connection with at least one of the two extrusion wheels, a gap between the two extrusion wheels in the first extrusion assembly is configured to allow the first filament to pass through, and the two extrusion wheels in the first extrusion assembly are configured to jointly clamp the first filament and convey the first filament to the first hot end assembly;
the second extrusion assembly is configured to drive a second filament so as to convey the second filament to the second hot end assembly.

2. The 3D printer according to claim 1, wherein the first hot end assembly is movably connected to the connecting frame, and the second hot end assembly is fixedly connected to the connecting frame.

3. The 3D printer according to claim 1, wherein the first hot end assembly is configured to eject a support material, and the second hot end assembly is configured to eject a main body portion of a three-dimensional product.

4. The 3D printer according to claim 1, wherein the first filament is a hard material filament, and the second filament is a soft material filament.

5. The 3D printer according to claim 1, further comprising a first filament tube and a second filament tube, wherein a diameter of the first filament tube is less than a diameter of the second filament tube;
the first filament tube is configured to connect the first hot end assembly, and the second filament tube is configured to connect the second hot end assembly;
the first filament passes through the first filament tube and is conveyed to the first hot end assembly, and the second filament passes through the second filament tube and is conveyed to the second hot end assembly.

6. The 3D printer according to claim 5, wherein the second filament tube is configured to allow a soft material filament to pass through, and an inner wall of the second filament tube is provided with an axial pattern.

7. The 3D printer according to claim 1, further comprising a housing and a frame, wherein the housing surrounds the frame to form a build space, the 3D printing head and the guide member are disposed in the build space, the guide member is in transmission connection with the frame, and the first extrusion assembly is detachably disposed on the housing.

8. The 3D printer according to claim 7, wherein the first extrusion assembly further comprises a first motor, a surface of the first motor is provided with a heat dissipation member, the first motor is in contact with an outer wall of the housing via the heat dissipation member, and the housing is a metal housing.

9. The 3D printer according to claim 5, further comprising a first filament tube connector and a second filament tube connector, wherein the second filament tube connector is detachably provided in a housing of the 3D printer in a penetrating manner, and the second filament tube is configured to allow the second filament to pass through;
the first filament tube connector is configured to connect the first filament tube so as to allow the first filament to pass through the first filament tube;
wherein an axial direction of the second filament tube connector is parallel to an axial direction of the first filament tube connector.

10. The 3D printer according to claim 9, further comprising a drag chain, wherein
the first filament tube and the second filament tube are respectively connected to the first hot end assembly and the second extrusion assembly along an extending direction of the drag chain.

11. The 3D printer according to claim 9, wherein an included angle between the first and second filament tube connectors and the housing ranges from 25° to 40°.

12. The 3D printer according to claim 1, wherein when the first hot end assembly ejects the first filament, a relative position between the first hot end assembly and the connecting frame is adjusted, such that a lowest position of the second hot end assembly is higher, in a Z-axis direction, than a lowest position of the first hot end assembly;
or when the second hot end assembly ejects the second filament in a molten state, a relative position between the first hot end assembly and the connecting frame is adjusted, such that a lowest position of the first hot end assembly is higher, in a Z-axis direction, than a lowest position of the second hot end assembly.

13. The 3D printer according to claim 1, wherein the 3D printer further comprises an impact mechanism, the 3D printing head further comprises a lifting mechanism connected to the connecting frame, the lifting mechanism is connected to the first hot end assembly, the lifting mechanism comprises a trigger member, and the trigger member is configured to collide with the impact mechanism to drive the first hot end assembly to move up and down.

14. The 3D printer according to claim 13, wherein the lifting mechanism comprises a gear and a first rotating shaft, and the first rotating shaft passes through the gear and is connected to the gear;
the first hot end assembly is fixedly connected to a rack; the rack meshes with the gear;
the first rotating shaft is connected to one end of the trigger member, and the other end of the trigger member is configured to collide with the impact mechanism.

15. The 3D printer according to claim 14, wherein the lifting mechanism further comprises a nozzle blocking sheet, a first connecting rod, and a second connecting rod; a first end of the first connecting rod is hinged to the first rotating shaft, and a second end of the first connecting rod is hinged to the second connecting rod;
the nozzle blocking sheet moves along with the second connecting rod, and the nozzle blocking sheet moves along with the second connecting rod to a position below the second hot end assembly when the first hot end assembly moves to a first position, or moves along with the second connecting rod to a position below the first hot end assembly when the second hot end assembly moves to a second position.
